(19) United States
(12) Patent Application Publication
(10) Pub. No.: US 2014/0093631 A1
(43) Pub. Date: Apr. 3, 2014

(54) Pasta compositions comprising phosphate salts and methods of making

(71) Applicant: ICL PERFORMANCE PRODUCTS LP, St. Louis, MO (US)

(72) Inventors: Lirong Zhou, St. Louis, MO (US); Nancy Cady Stachiw, Fenton, MO (US); Gary G. Hou, Portland, OR (US)

(73) Assignee: ICL Performance Products LP, St. Louis, MO (US)

(21) Appl. No.: 13/838,688

(22) Filed: Mar. 15, 2013

Related U.S. Application Data
(60) Provisional application No. 61/707,543, filed on Sep. 28, 2012.

(51) Int. Cl. A23L 1/16

(52) U.S. Cl. CPC A23L 1/16
USPC 426/557

(57) ABSTRACT

The present invention relates to methods and compositions for enhancing pastas by the addition of phosphate salts. The addition of phosphate salts and blends of phosphate salt has been found to improve properties such as texture and firmness. The addition of phosphate salts has also been found to reduce the need for additional ingredients such as egg whites or other additives.

### CROSS REFERENCE TO RELATED APPLICATIONS

This application claims the benefit under 35 U.S.C. §119(e) of U.S. Provisional Application No. 61/807,543, filed Sep. 28, 2012, which is incorporated by reference in its entirety.

### BACKGROUND OF THE INVENTION

Traditionally, the preparation of pasta products includes mixing flour and water to form a homogeneous mixture, kneading of the mixture, and forming into the final shape. The resultant fresh pastas are further processed to produce dried, shelf stable, chilled, or frozen forms. Although dried pastas are a dominant form in the marketplace, microwavable frozen pasta cuisines are becoming popular because of ease of preparation for the consumers.

Frozen pasta cuisines are generally produced from fresh pasta or dried pasta by boiling the pasta to optimum cooking, cooling and rinsing with cold water, filling the cooked pastas and sauce into a container, covering the container, packing the container into a carton box, freezing them to specific core temperature, and storing in freezers. In commercial production, however, cooked pastas are often soaked in a large trough before being packed into individual containers with the sauce, and the soaking time varies with the production schedule. If the soaking time is extended, the texture of the cooked pasta will be negatively affected. Like any other frozen food products, frozen pasta cuisines are subjected to several freeze-thaw cycles during storage and transportations. These freeze-thaw cycles will negatively affect the pasta texture as well. As a result, improvement of frozen pasta texture stability can be an important issue for the manufacturer.

Whole grain pastas are becoming more popular because of their nutritional and health benefits. Whole wheat pastas are generally made from at least 51% whole wheat flour and 49% regular semolina. Egg is often added into recipes to provide additional strength to dough and improve pasta bite. However, the products still have much room for quality improvement and raw material costs need to be further reduced.

### SUMMARY OF THE INVENTION

One aspect of the invention provides for a pasta composition comprising flour, water, and a phosphate salt. In certain embodiments, the phosphate salt is in an amount of from about 0.05% to about 5.0% by weight of the flour, or the phosphate salt is in an amount of from about 0.1% to about 1.0% by weight of the flour, or the phosphate salt is in an amount of from about 0.15% to about 0.5% by weight of the flour. The pasta composition may be any of varies types of pasta including, but not limited to, a shelf stable pasta, a dry pasta, a fresh pasta, a refrigerated pasta, or a frozen pasta. An certain embodiments, the pasta is raw, half cooked, or cooked. Further, the pasta composition may be a fresh pasta, a refrigerated pasta, or a frozen pasta, and in certain embodiments, the pasta composition is a cooked refrigerated pasta or a cooked frozen pasta. In certain embodiments, the pasta composition is a semolina, wheat, or whole wheat pasta. The phosphate salt may be of various phosphate salts suitable for food use and in certain embodiments is selected from the group consisting of MSP, DSP, TSP, SAPP, TSPP, STPP, STMP, SHMP, DKP, DMP, SKMP, TCP, CAPP, MKP, TKPP, DCP, MCP, TKP, KTPP, phosphoric acid, and SALP. In certain embodiments, the phosphate salt is selected from the group consisting of MSP, DSP, TSP, SAPP, TSPP, STPP, STMP, SHMP, DKP, SKMP, TCP, and CAPP and in certain embodiments, the phosphate salt is selected from the group consisting of TCP, CAPP, SAPP, and SKMP. In certain embodiments, the pasta composition comprises a blend of two or more phosphate salts. In certain embodiments, the blend of phosphate salts is a blend of two or more of MSP, DSP, TSP, SAPP, TSPP, STPP, STMP, SHMP, DKP, SKMP, TCP, and CAPP. In certain embodiments, the blend of phosphate salts is a blend of two or more of CAPP, TCP, SAPP, and SKMP. In certain embodiments, the blend of phosphate salts is selected from the group consisting of a 0.1% CAPP+0.4% TCP, 0.2% CAPP+0.4% TCP, 0.2% CAPP+0.3% TCP, and 0.3% CAPP+0.2% TCP by weight of the flour. Egg white may be added to the pasta composition. In certain embodiments, the pasta composition comprises up to about 10% by weight of the flour of egg white, such as from about 2% to about 7% by weight of the flour of egg white. In certain embodiments, the pasta composition comprises less than 2% by weight of the flour of egg white, such as about 1.5% by weight of the flour of egg white. In addition to the option of adding egg white, in certain embodiments, the pasta composition comprises at least one additive selected from the group consisting of gluten, soy protein, gums, starches, fiber, and emulsifiers.

Another aspect of the invention provides for a method of making a pasta composition comprising mixing a phosphate salt with a pasta dough comprising flour and water. In certain embodiments, the phosphate salt is in an amount of from about 0.05% to about 5.0% by weight of the flour, is in an amount of from about 0.1% to about 1.0% by weight of the flour, or is in an amount of from about 0.15% to about 0.5% by weight of the flour. The pasta may be a shelf stable pasta, a dry pasta, a fresh pasta, a refrigerated pasta, or a frozen pasta, and it may be raw, half cooked, or cooked. In certain embodiments, the pasta composition is a fresh pasta, a refrigerated pasta, or a frozen pasta, such as a cooked refrigerated pasta or a cooked frozen pasta. In certain embodiments, the pasta composition is a semolina, wheat, or whole wheat pasta. In certain embodiments of a method of the invention, the phosphate salt is selected from the group consisting of MSP, DSP, TSP, SAPP, TSPP, STPP, STMP, SHMP, DKP, DMP, SKMP, TCP, CAPP, MKP, TKPP, DCP, MCP, TKP, KTPP, phosphoric acid, and SALP. In certain embodiments, the phosphate salt is selected from the group consisting of MSP, DSP, TSP, SAPP, TSPP, STPP, STMP, SHMP, DKP, SKMP, TCP, and CAPP. In certain embodiments, the phosphate salt is selected from the group consisting of TCP, CAPP, SAPP, and SKMP. In certain embodiments, the method comprises mixing a blend of two or more phosphate salts with the pasta dough. In certain embodiments, the blend of phosphate salts is a blend of two or more of MSP, DSP, TSP, SAPP, TSPP, STPP, STMP, SHMP, DKP, SKMP, TCP, and CAPP. In certain embodiments, the blend of phosphate salts is a blend of two or more of CAPP, TCP, SAPP, and SKMP. In certain embodiments, the blend of phosphate salts is selected from the group consisting of a 0.1% CAPP+0.4% TCP, 0.2% CAPP+0.4% TCP, 0.2% CAPP+0.3% TCP, and 0.3% CAPP+0.2% TCP by weight of the flour. In certain embodiments of the methods, egg white may be added to the pasta composition. In certain embodiments, the pasta composition comprises up to about 10% by weight of the flour of egg white, such as from about 2% to about 7% by weight of the flour of egg white. In certain embodiments, the pasta composition comprises less than 2% by weight of the flour of egg white, such as about 1.5% by weight of the flour of egg white. In addition to the option of adding egg white, in certain embodiments, the pasta composition comprises at least one additive selected from the group consisting of gluten, soy protein, gums, starches, fiber, and emulsifiers.

These and other aspects of the invention will become apparent to those skilled in the art in light of the following disclosure and accompanying drawings.

### BRIEF DESCRIPTION OF THE DRAWINGS

For a better understanding of the present invention, reference may be made to the accompanying drawings in which:

FIG. 1 shows the firmness and hardness following 4 cycles of freeze-thaw of whole wheat pasta when adding 0.25% (A and B, respectively) and 0.5% (C and D respectively) of phosphates salts.

FIG. 2 shows changes of firmness, hardness, and chewiness of pasta by adding varied levels of tricalcium phosphate after 4 cycles of freeze-thaw (A-C, respectively).

FIG. 3 show changes of firmness, hardness, and chewiness of pasta by adding varied levels of calcium acid pyrophosphate after 4 cycles of freeze-thaw (A-C, respectively).

FIG. 4 shows changes of firmness and hardness by adding varied levels of sodium acid pyrophosphate after 4 cycles of freeze thaw (A-B, respectively).

FIG. 5 shows changes of firmness, hardness, springiness, and chewiness by adding varied levels of sodium potassium hexametaphosphate after 4 cycles of freeze-thaw (A-D, respectively).

FIG. 6 shows the firmness, hardness, and springiness (A-C, respectively) of frozen whole wheat pasta with 1.5% egg white by adding four phosphate salts and their partial blends.

FIG. 7. Shows the firmness (A) and hardness (B) of frozen hard whole wheat with varied levels of egg white and 0.3% calcium acid pyrophosphate.

FIG. 8 shows changes of firmness (A) and hardness (B) of pasta after soaking for 5 to 30 minutes.

FIG. 9 shows the stability (A) and C2 value (B) at the addition levels of 0.25% and 0.5% of PSs respectively.

### DETAILED DESCRIPTION

In the following detailed description, numerous specific details are set forth in order to provide a thorough understanding of the invention. The following disclosed embodiments, however, are merely representative of the invention which may be embodied in various forms. It will be understood by those skilled in the art that the present invention may be practiced without these specific details. Thus, specific structural, functional, and procedural details described are not to be interpreted as limiting. In other instances, well-known methods, procedures, and components have not been described in detail so as not to obscure the present invention.

Headings are provided herein solely for ease of reading and should not be interpreted as limiting.

### DEFINITIONS

As used herein, “MSP” is the abbreviation of monosodium phosphate.

As used herein, “DSP” is the abbreviation of disodium phosphate.

As used herein, “TSP” is the abbreviation of trisodium phosphate.

As used herein, “SAPP” is the abbreviation of sodium acid pyrophosphate.

As used herein, “TSPP” is the abbreviation of tetrasodium pyrophosphate.

As used herein, “STPP” is the abbreviation of sodium tripolyphosphate.

As used herein, “STMP” is the abbreviation of sodium trimetaphosphate.

As used herein, “SHMP” is the abbreviation of sodium hexametaphosphate.

As used herein, “DKP” is the abbreviation of dipotassium phosphate.

As used herein, “SKMP” is the abbreviation of sodium potassium hexametaphosphate.

As used herein, “TCP” is the abbreviation of tricalcium phosphate.

As used herein, “CAPP” is the abbreviation of calcium acid pyrophosphate.

As used herein, “MKP” is the abbreviation of monopotassium phosphate.

As used herein “TKPP” is the abbreviation of tetrapotassium phosphate.

As used herein, “DCP” is the abbreviation of dicalcium phosphate.

As used herein, “MCP” is the abbreviation of monocalcium phosphate.

As used herein, “TKP” is the abbreviation of tripotassium phosphate.

As used herein, “KTPP” is the abbreviation of potassium tripolyphosphate.

As used herein, “SALP” is the abbreviation of sodium aluminum phosphate.

As used herein, “DMP” is the abbreviation of dimagnesium phosphate.

### OVERVIEW

The present invention is drawn to new and improved methods and compositions for producing pastas comprising the use of phosphate salts and phosphate salt blends to improve various qualities such as texture. Certain methods and compositions have been discovered that improve upon the overall quality and reduce the raw material costs of pasta, including frozen and/or whole wheat pasta, comprising the use of selected phosphate salts and their blends. Certain aspects of the present invention are drawn to: 1) using phosphate salts to improve the pasta cooking property (cooking yield and cooking loss); 2) using phosphate salts to improve the textural stability of soaked pasta due to extended soaking time; 3) using phosphate salts to improve the textural stability of frozen pastas after one or more freeze-thaw cycles; and 4) using certain levels of phosphate blends to yield overall improved frozen pasta quality.

### Pasta Compositions

Pasta compositions of the invention are drawn to improving various types of pastas such as dry pasta, shelf stable pasta (such as, canned or packaged), fresh pasta, refrigerated pasta, and frozen pasta. In certain embodiments, the pasta is raw, half-cooked, or cooked. The pasta may be any of the known types of pasta using various flours and flour blends such as, but not limited to: durum semolina, durum flour, regular wheat flour, whole wheat flour, gluten free flours, and blends of these and other flours. In certain embodiments, a pasta composition of the invention comprises flour, water, and a phosphate salt. In certain embodiments, a pasta composition is fresh whole wheat pasta, a frozen whole wheat pasta, a fresh semolina pasta, a frozen semolina pasta, or a fresh blend or frozen blend thereof.

One aspect of the invention is the use of phosphate salts in a pasta composition. Representative examples of phosphate salts include, but are not limited to: MSP, DSP, TSP, SAPP, TSPP, STPP, STMP, SHMP, DKP, DMP, SKMP, TCP, MKP, TKPP, DCP, MCP, TKP, KTPP, SALP, phosphoric acid, and CAPP. In certain embodiments, the phosphate salt is selected from the group consisting of TCP, CAPP, SAPP, and SKMP. In certain embodiments, the pasta composition comprises a blend of phosphate salts. By “blend of phosphate salts” it is meant that more than one type of phosphate salt is included int the pasta composition or method of making the pasta composition. Two or more phosphate salts may be combined before being added to the pasta composition or they may added separately to form a blend once included in the pasta composition. In certain embodiments, a blend may comprise two or more of MSP, DSP, TSP, SAPP, TSPP, STPP, STMP, SHMP, DKP, DMP, SKMP, TCP, MKP, TKPP, DCP, MCP, TKP, KTPP, SALP, phosphoric acid, and CAPP. In certain embodiments, a blend may comprise two or more of MSP, DSP, TSP, SAPP, TSPP, STPP, STMP, SHMP, DKP, SKMP, TCP, and CAPP. In certain embodiments, a blend may comprise two or more of CAPP, TCP, SAPP, and SKMP. In certain embodiments, a blend may comprise CAPP and TCP. It has been discovered that certain blends of phosphate salts are particularly useful, such as but not limited to: 0.1% CAPP+0.4% TCP; 0.2% CAPP+0.4% TCP; 0.2% CAPP+0.3% TCP; and 0.3% CAPP+0.2% TCP by weight of the flour.

The use of phosphate salts in pasta compositions have been found to result in improvements in certain qualities of the pasta. In certain embodiments, qualities such as firmness and texture of a frozen pasta comprising a phosphate salt, including a whole wheat pasta, remain more desirable after one or more freeze-thaw cycles as compared to a frozen pasta made by standard methods.

In certain embodiments of the present invention, a pasta composition includes about 0.05%, 0.1%, 0.15%, 0.2%, 0.25%, 0.3%, 0.4%, 0.5%, 0.6%, 0.75%, 1.0%, 2.0%, 3.0%, 4.0% or about 5.0% of a phosphate salt or blend of phosphate salts. (All percentages herein are based on weight of the flour unless otherwise specified).

In certain embodiments of the present invention, a pasta composition comprises from about 0.05% to about 5.0% of a phosphate salt, or from about 0.1% to about 5% of a phosphate salt, or from about 1% to about 5% of a phosphate salt. In certain embodiments of the present invention, a pasta composition comprises from about 0.05% to about 4.0% of a phosphate salt, or from about 0.1% to about 4% of a phosphate salt, or from about 1% to about 4% of a phosphate salt. In certain embodiments of the present invention, a pasta composition comprises from about 0.05% to about 3.0% of a phosphate salt, or from about 0.1% to about 3% of a phosphate salt, or from about 1% to about 3% of a phosphate salt. In certain embodiments of the present invention, a pasta composition comprises from about 0.05% to about 2.0% of a phosphate salt, or from about 0.1% to about 2% of a phosphate salt, or from about 1% to about 2% of a phosphate salt. In certain embodiments of the present invention, a pasta composition includes from about 0.1% to about 1.0% of a phosphate salt, or from about 0.2% to about 1.0% of a phosphate salt, or from about 0.3% to about 1.0% of a phosphate salt, or from about 0.4% to about 1.0% of a phosphate salt, or from about 0.5% to about 1.0% of a phosphate salt. In certain embodiments of the present invention, the pasta includes from about 0.1% to about 0.75% of a phosphate salt, or from about 0.2% to about 0.75% of a phosphate salt, or from about 0.3% to about 0.75% of a phosphate salt, or from about 0.4% to about 0.75% of a phosphate salt, or from about 0.5% to about 0.75% of a phosphate salt. In certain embodiments of the present invention, the pasta includes from about 0.1% to about 0.5% of a phosphate salt, or from about 0.2% to about 0.5% of a phosphate salt, or from about 0.3% to about 0.5% of a phosphate salt, or from about 0.4% to about 0.5% of a phosphate salt. In certain embodiments, the phosphate salt included may be a blend of phosphate salts. In certain embodiments of the present invention, the pasta includes from about 0.15% to about 0.25% of a phosphate salt, or from about 0.15% to about 0.5% of a phosphate salt, or from about 0.15% to about 0.75% of a phosphate salt, or from about 0.15% to about 1.0% of a phosphate salt. In certain embodiments of the present invention, the pasta includes from about 0.25% to about 0.4% of a phosphate salt, or from about 0.25% to about 0.5% of a phosphate salt, or from about 0.25% to about 0.75% of a phosphate salt, or from about 0.25% to about 1.0% of a phosphate salt. In certain embodiments, the phosphate salt included may be a blend of phosphate salts.

Egg whites are an ingredient often used in making pasta. In certain embodiments, a pasta composition of the invention may comprise up to about 10% by weight of the flour of dried egg white. In certain embodiments, a pasta composition of the invention may comprise up to about 9%, 8%, 7%, 6%, 5%, 4%, 3%, or 2% by weight of the flour of egg white. In certain embodiments, a pasta composition of the invention may comprise from about 2% to about 10%, from about 2% to about 8%, from about 2% to about 7%, from about 2% to about 6%, from about 2% to about 5%, from about 2% to about 4%, or from about 2% to about 3% by weight of the flour of egg white.

In certain embodiments, the use of egg whites in a pasta recipe is reduced by the addition of a phosphate salt to the recipe. Depending on the type and amount of phosphate salt as described herein, varying amounts of egg white reduction in the pasta composition may be achieved. In certain embodiments of a pasta composition comprising a phosphate salt, the pasta composition comprises less than about 2% egg white, less than about 1.9% egg white, less than about 1.8% egg white, less than about 1.7% egg white, less than about 1.6% egg white, less than about 1.5% egg white, less than about 1.4% egg white, less than about 1.3% egg white, less than about 1.2% egg white, less than about 1.1% egg white, or less than about 1.0% egg white. In certain embodiments of a pasta composition comprising a phosphate salt, the pasta composition comprises about 1.9% egg white, about 1.8% egg white, about 1.7% egg white, about 1.6% egg white, about 1.5% egg white, about 1.4% egg white, about 1.3% egg white, about 1.2% egg white, about 1.1% egg white, or about 1.0% egg white. The percentage of egg white is the percent by weight of the flour.

In addition to egg whites, other additives such as gluten, soy protein, gums, starches, fiber, or emulsifiers, may be added to pastas to improve characteristics including pasta firmness, texture, and reduced stickiness. Any of these may be added to a pasta composition of the invention. In certain embodiments, a pasta composition of the invention comprises one or more additives selected from the group consisting of gluten, soy protein, gums, starches, fiber, and emulsifiers.

Without being bound by theory, it is thought that phosphate salts may provide similar functions to current pasta additives. Thus it is contemplated that as with egg whites, the use of phosphate salts may reduce the amounts required or need for other additives.

In certain embodiments, pasta compositions comprising phosphate salts and/or pastas made by methods of the present invention exhibit desirable and/or enhanced cooking properties such as to cooking yield and cooking loss.

### Methods of Making

Certain aspects of the invention provide for methods of making a pasta composition with improved qualities by adding phosphate salts to the pasta dough. The method of making a pasta composition is well known. It can be done on a small scale up to mass production using industrial food processing equipment. The phosphate salt may be added at any point during the preparation of the dough and may be added to a separate individual ingredient, wet or dry ingredients of the dough before they are combined, or to the dough after two or more of the ingredients have been combined.

The pasta composition may be any of various types of pastas such as dry pasta, shelf stable pasta (such as, canned or packaged), fresh pasta, refrigerated pasta, and frozen pasta. In certain embodiments, the pasta is raw, half-cooked, or cooked. The pasta may be any of the known types of pasta using various flours and flour blends such as, but not limited to: durum semolina, durum flour, regular wheat flour, whole wheat flour, gluten free flours, and blends of these and other flours. In certain embodiments, a pasta composition of the invention comprises flour, water, and a phosphate salt.

The amounts, types, and blends of phosphate salts for use in the methods are the same as those of a pasta composition of the invention. The methods also provide for the addition of one or more additives described herein. In certain embodiments, the additive is selected from the group consisting of egg white, gluten, soy protein, gums, starches, fiber, and emulsifiers. The methods also provide for reducing the amount of egg white used in a pasta composition by the addition of a phosphate salt to the pasta recipe.

### EXAMPLES

The following disclosed embodiments are merely representative of the invention which may be embodied in various forms. Thus, specific structural, functional, and procedural details disclosed in the following examples are not to be interpreted as limiting.

### Example 1

### Screening Phosphate Salts at Addition Levels of 0.25% and 0.5%, Respectively, after 4 Cycles of Freeze-Thaw

The determination of firmness and TPA was according to the method of AACC 66-50.01 and Hou (2010).

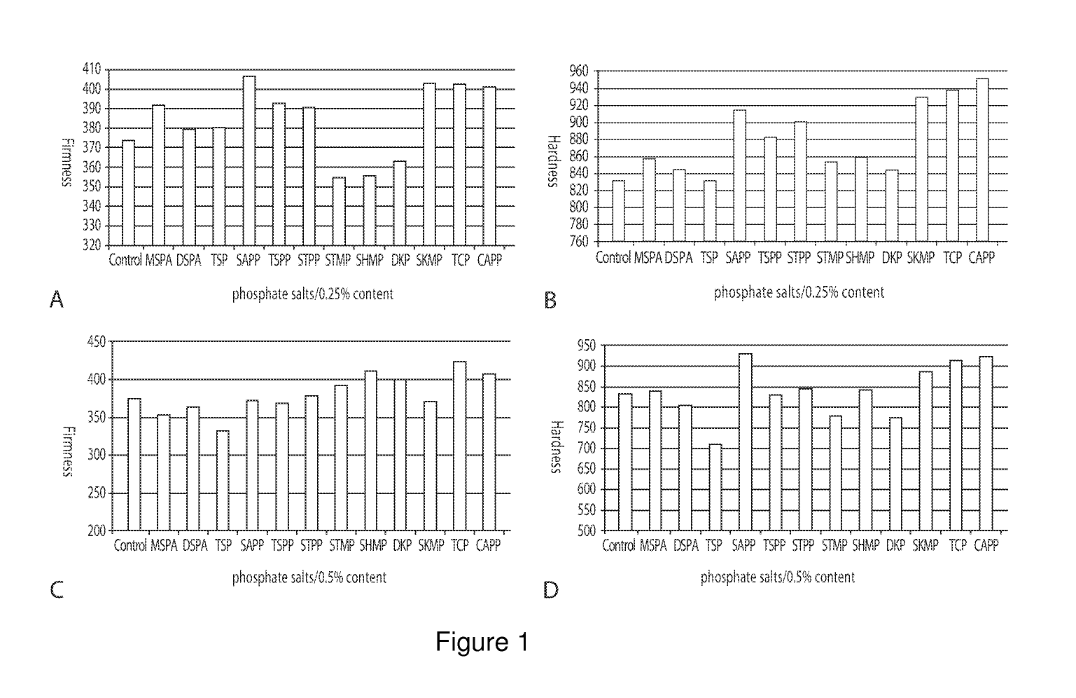

In this representative example, 12 types of phosphate salts were screened based on two main indexes of pasta textural properties, firmness and hardness, after 4 freeze-thaw cycles at the addition levels of 0.25% and 0.5%, respectively. The results indicated that the type of phosphate salts had varied effects on the textural stability of frozen whole wheat pasta (no egg white), and most of them showed a positive effect on the stability after 4 cycles of freeze-thaw at the addition level of 0.25%. TCP, CAPP, SAPP and SKMP significantly increased the firmness and hardness of cooked pasta compared with the control sample (Table 1 and FIGS. 1A&B).

At the 0.5% addition level, SHMP, TCP and CAPP yielded more increase of firmness of frozen whole wheat pasta than other phosphate salts did (Table 1 and FIG. 1 C), while TCP, CAPP, SAPP and SKMP were more effective in pasta hardness improvement (Table 2 and FIG. 1D). Some other parameters of pasta TPA (texture profile analysis), such as springiness and chewiness, were also improved by adding TCP, CAPP, SAPP and SKMP (Table 1 & 2).

TABLE 1
Firmness and texture profile analysis (TPA) of whole wheat pasta by adding 0.25% of phosphate salts after 4
cycles of freeze-thaw.

| PSs | Firmness | Hardness | Springiness | Cohesiveness | Chewiness | Resilience |
|---|---|---|---|---|---|---|
| Control | 373.74 ± 5.44^{bc} | 831.38 ± 7.51^{a} | 0.915 ± 0.010^{b} | 0.533 ± 0.005^{abc} | 407.73 ± 5.40^{a} | 0.229 ± 0.005^{a} |
| MSPA | 392.14 ± 4.29^{de} | 857.03 ± 7.09^{b} | 0.946 ± 0.001^{c} | 0.535 ± 0.002^{abc} | 446.59 ± 9.12^{bcd} | 0.245 ± 0.004^{b} |
| DSPA | 379.58 ± 12.3^{cd} | 844.60 ± 3.91^{ab} | 0.947 ± 0.006^{c} | 0.571 ± 0.018^{e} | 466.02 ± 2.48^{cdef} | 0.267 ± 0.003^{e} |
| TSP | 380.29 ± 0.67^{cd} | 832.03 ± 3.85^{a} | 0.961 ± 0.006^{cd} | 0.551 ± 0.001^{bcde} | 427.82 ± 9.68^{ab} | 0.257 ± 0.001^{d} |
| SAPP | 406.59 ± 14.21^{f} | 914.41 ± 0.71^{de} | 0.954 ± 0.004^{cd} | 0.543 ± 0.001^{abcd} | 474.02 ± 1.46^{defg} | 0.252 ± 0.001^{bcd} |
| TSPP | 392.74 ± 0.62^{def} | 882.42 ± 3.14^{c} | 0.932 ± 0.010^{bc} | 0.551 ± 0.006^{bcde} | 453.63 ± 5.67^{bcde} | 0.247 ± 0.00^{bc} |
| STPP | 390.67 ± 0.98^{de} | 900.74 ± 2.29^{cd} | 0.957 ± 0.001^{cd} | 0.564 ± 0.003^{de} | 489.58 ± 1.07^{fg} | 0.251 ± 0.003^{bcd} |
| STMP | 354.86 ± 3.17^{a} | 853.13 ± 3.56^{ab} | 0.876 ± 0.017^{a} | 0.537 ± 0.013^{abc} | 398.72 ± 2.17^{a} | 0.234 ± 0.003^{a} |
| SHMP | 355.85 ± 0.70^{a} | 859.24 ± 3.54^{b} | 0.917 ± 0.023^{b} | 0.526 ± 0.005^{a} | 403.72 ± 2.03^{a} | 0.231 ± 0.001^{a} |
| DKP | 363.37 ± 1.68^{ab} | 844.06 ± 3.40^{ab} | 0.977 ± 0.010^{d} | 0.555 ± 0.006^{cde} | 438.24 ± 4.87^{bc} | 0.255 ± 0.002^{cd} |
| SKMP | 402.97 ± 2.96^{ef} | 929.53 ± 1.20^{ef} | 0.933 ± 0.001^{bc} | 0.531 ± 0.001^{ab} | 480.07 ± 4.48^{efg} | 0.248 ± 0.005^{bcd} |
| TCP | 402.52 ± 5.18^{ef} | 938.02 ± 4.41^{f} | 0.934 ± 0.010^{bc} | 0.541 ± 0.019^{abcd} | 500.17 ± 3.32^{g} | 0.254 ± 0.005^{bcd} |
| CAPP | 401.47 ± 5.37^{ef} | 951.18 ± 5.58^{f} | 0.957 ± 0.020^{cd} | 0.550 ± 0.016^{bcde} | 488.54 ± 6.45^{fg} | 0.250 ± 0.008^{bcd} |

All data are reported as means ± standard deviations.
The different letters after the values in the same column indicate the means is significantly different (p < 0.05).
ns means non-significant.

TABLE 2
Firmness and TPA of hard whole wheat pasta by adding 0.5% content of phosphate salts after 4 cycles of freeze-thaw.

| PSs | Firmness | Hardness | Springiness | Cohesiveness | Chewiness | Resilience |
|---|---|---|---|---|---|---|
| Control | 373.74 ± 5.44^{c} | 831.38 ± 7.51^{cd} | 0.915 ± 0.010^{a} | 0.533 ± 0.005^{ab} | 407.73 ± 5.40^{bc} | 0.229 ± 0.005^{abc} |
| MSPA | 352.71 ± 3.90^{b} | 837.91 ± 1.73^{d} | 0.962 ± 0.007^{abcd} | 0.539 ± 0.002^{bc} | 437.24 ± 0.45^{defg} | 0.239 ± 0.001^{bcde} |
| DSPA | 362.96 ± 0.33^{bc} | 802.94 ± 6.75^{bc} | 0.976 ± 0.010^{e} | 0.565 ± 0.001^{d} | 433.18 ± 5.69^{def} | 0.254 ± 0.001^{f} |
| TSP | 330.93 ± 0.97^{a} | 708.30 ± 2.38^{a} | 0.936 ± 0.004^{abc} | 0.556 ± 0.005^{cd} | 370.69 ± 2.45^{a} | 0.248 ± 0.001^{ef} |
| SAPP | 371.59 ± 16.97^{c} | 928.74 ± 16.11^{f} | 0.927 ± 0.021^{ab} | 0.533 ± 0.003^{ab} | 460.20 ± 2.25^{h} | 0.231 ± 0.012^{abcd} |
| TSPP | 368.25 ± 1.75^{bc} | 828.39 ± 2.97^{cd} | 0.912 ± 0.006^{a} | 0.547 ± 0.006^{bcd} | 397.79 ± 5.35^{b} | 0.233 ± 0.002^{abcd} |
| STPP | 377.97 ± 3.49^{cd} | 842.97 ± 11.92^{d} | 0.940 ± 0.002^{abcd} | 0.547 ± 0.004^{bcd} | 447.08 ± 2.77^{efgh} | 0.244 ± 0.001^{cdef} |
| STMP | 391.34 ± 6.8.^{de} | 778.86 ± 1.97^{b} | 0.931 ± 0.008^{ab} | 0.527 ± 0.001^{ab} | 374.56 ± 4.26^{a} | 0.223 ± 0.003^{a} |
| SHMP | 410.65 ± 7.47^{fg} | 840.96 ± 0.37^{d} | 0.962 ± 0.004^{cde} | 0.529 ± 0.001^{ab} | 428.31 ± 2.86^{cde} | 0.228 ± 0.002^{ab} |
| DKP | 398.92 ± 0.80^{ef} | 773.44 ± 5.00^{b} | 0.924 ± 0.030^{ab} | 0.546 ± 0.005^{bcd} | 421.96 ± 6.15^{cd} | 0.235 ± 0.001^{abcde} |
| SKMP | 369.99 ± 5.83^{c} | 884.98 ± 9.53^{e} | 0.949 ± 0.017^{bcde} | 0.517 ± 0.010^{a} | 416.71 ± 3.34^{bcd} | 0.221 ± 0.002^{a} |
| TCP | 423.32 ± 1.70^{g} | 913.29 ± 1.95^{ef} | 0.941 ± 0.006^{abcd} | 0.537 ± 0.006^{abc} | 454.77 ± 9.22^{fgh} | 0.245 ± 0.002^{def} |
| CAPP | 407.50 ± 5.21^{efg} | 922.06 ± 14.35^{f} | 0.966 ± 0.006^{cde} | 0.529 ± 0.026^{ab} | 458.73 ± 11.11^{gh} | 0.239 ± 0.017^{bcde} |

All data are reported as means ± standard deviations.
The different letters after the values in the same column indicate the means is significantly different (p < 0.05).
ns means non-significant.

### Example 2

### Effect of Addition Levels of TCP, CAPP, SAPP and SKMP on the Textural Stability of Frozen Whole Wheat Pasta

The determination of firmness and TPA was mainly according to the method of Sissons et al (2008), AACC 66-50.01 and Hou (2010).

2.1 Effects of Different Addition Levels of TCP.

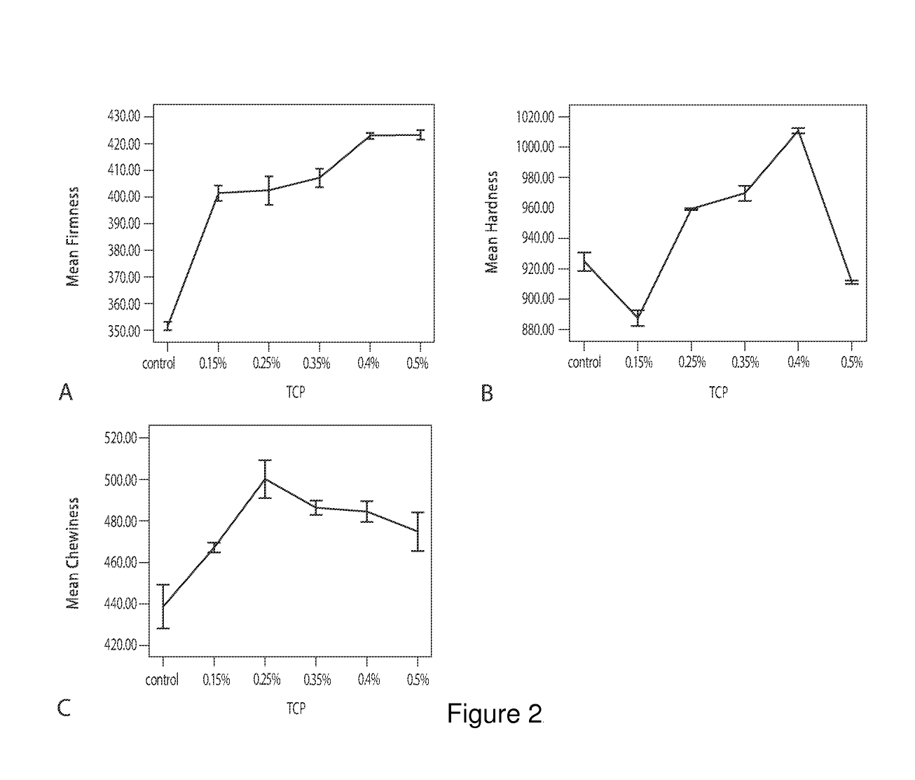

At all addition levels of TCP (from 0.15% to 0.5%), the firmness of frozen whole wheat pasta was more significantly increased than the control (Table 3), and up to the maximum level of 0.4-0.5%. The hardness value was the maximum as the addition level of TCP was at 0.4% (FIG. 2B). The springiness and chewiness values were higher than the control by adding TCP.

TABLE 3
Firmness and TPA of whole wheat pasta by adding TCP after 4 cycles of freeze-thaw.

| PSs(%) | Firmness | Hardness | Springiness | Cohesiveness | Chewiness | Resilience |
|---|---|---|---|---|---|---|
| Control | 351.60 ± 1.59^{a} | 924.74 ± 6.12^{c} | 0.925 ± 0.003^{a} | 0.504 ± 0.004^{a} | 438.74 ± 10.54^{a} | 0.227 ± 0.001^{a} |
| 0.15 | 401.36 ± 2.89^{b} | 887.5 ± 5.11^{a} | 0.955 ± 0.007^{bc} | 0.554 ± 0.004^{b} | 467.21 ± 2.36^{b} | 0.244 ± 0.001^{b} |
| 0.25 | 402.43 ± 5.31^{b} | 959.25 ± 0.53^{d} | 0.964 ± 0.015^{c} | 0.564 ± 0.012^{bc} | 500.17 ± 9.32^{c} | 0.254 ± 0.005^{c} |
| 0.35 | 407.16 ± 3.46^{b} | 969.62 ± 5.01^{e} | 0.965 ± 0.012^{c} | 0.575 ± 0.004^{c} | 486.4 ± 3.49^{bc} | 0.266 ± 0.001^{d} |
| 0.40 | 422.9 ± 1.10^{c} | 1010.75 ± 1.75^{f} | 0.962 ± 0.001^{c} | 0.510 ± 0.001^{a} | 484.53 ± 5.05^{bc} | 0.227 ± 0.002^{a} |
| 0.50 | 423.29 ± 1.75^{c} | 911.17 ± 1.06^{b} | 0.960 ± 0.021^{c} | 0.516 ± 0.008^{a} | 474.8 ± 9.29^{bc} | 0.230 ± 0.006^{a} |

All data are reported as means ± standard deviations.
The different letters after the values in the same column indicate the means is significantly different (p < 0.05).
ns means non-significant.

2.2 Effect of Different Addition Levels of CAPP.

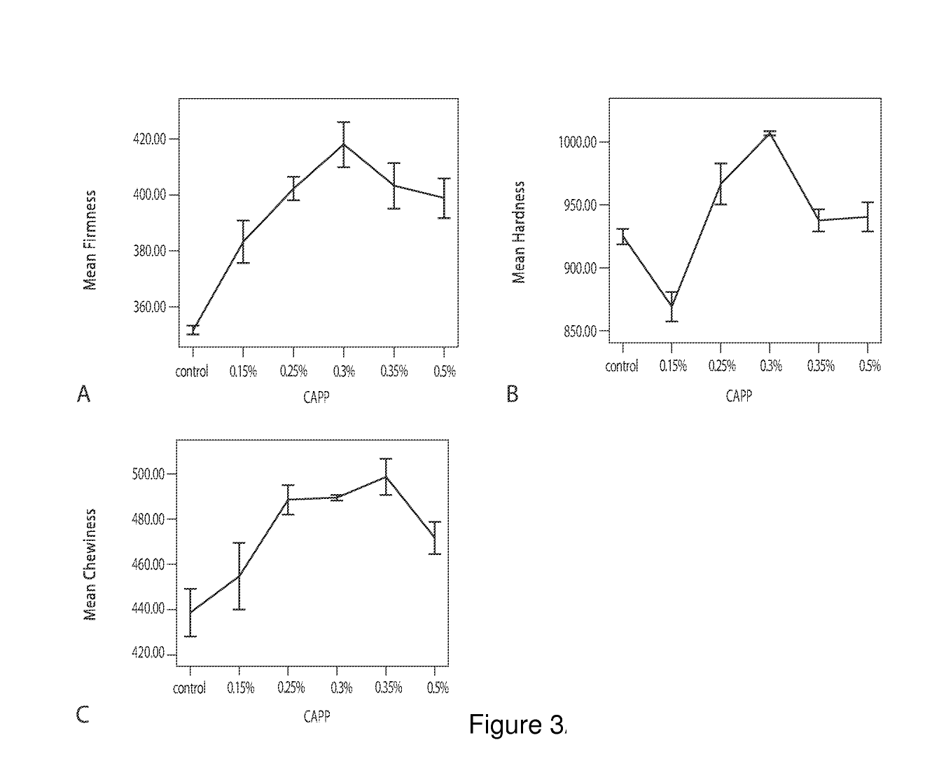

The firmness and hardness values were up to the maximum at the addition level of 0.3% from FIGS. 3 A & B, which were significantly higher than the control. The chewiness value was up to the maximum at the addition level of 0.35%. The springiness, cohesiveness and chewiness values were also improved by adding CAPP, but the resilience value didn't show significant difference from the control (Table 4).

TABLE 4
Firmness and TPA of hard whole wheat pasta by adding CAPP after 4 cycles of freeze-thaw.

| PSs | | | | | | |
|---|---|---|---|---|---|---|
| content % | Firmness | Hardness | Springiness | Cohesiveness | Chewiness | Resilience^{ns} |
| Control | 351.60 ± 1.59^{a} | 924.74 ± 6.12^{b} | 0.925 ± 0.003^{a} | 0.504 ± 0.004^{a} | 438.74 ± 10.54^{a} | 0.227 ± 0.001 |
| 0.15 | 383.23 ± 8.64^{b} | 869.13 ± 11.70^{a} | 0.965 ± 0.001^{b} | 0.554 ± 0.003^{b} | 454.78 ± 14.77^{ab} | 0.251 ± 0.005 |
| 0.25 | 402.3 ± 4.19^{bc} | 966.61 ± 16.25^{c} | 0.960 ± 0.028^{b} | 0.563 ± 0.003^{b} | 488.54 ± 6.45^{cd} | 0.258 ± 0.004 |
| 0.30 | 417.98 ± 8.06^{c} | 1006.98 ± 1.59^{d} | 0.962 ± 0.003^{b} | 0.560 ± 0.004^{b} | 489.50 ± 1.24^{cd} | 0.254 ± 0.037 |
| 0.35 | 403.27 ± 8.18^{bc} | 937.7 ± 8.75^{b} | 0.976 ± 0.001^{c} | 0.560 ± 0.001^{b} | 498.64 ± 7.92^{d} | 0.255 ± 0.001 |
| 0.50 | 398.82 ± 7.06^{bc} | 940.4 ± 11.6^{b} | 0.966 ± 0.006^{bc} | 0.554 ± 0.009^{b} | 471.63 ± 7.13^{bc} | 0.253 ± 0.002 |

All data are reported as means ± standard deviations.
The different letters after the values in the same column indicate the means is significantly different (p < 0.05).
ns means non-significant.

2.3 Effects of Different Addition Levels of SAPP.

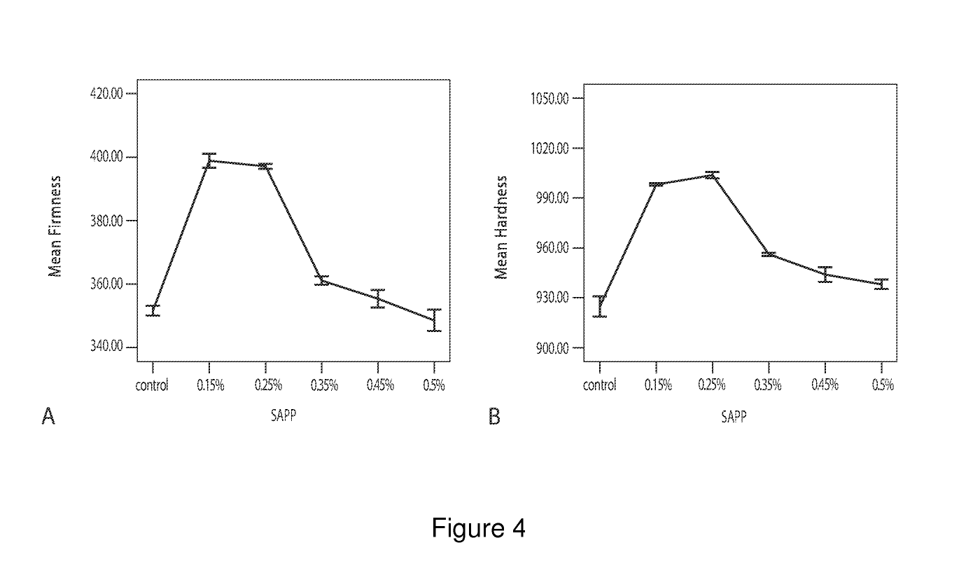

From the Table 5 and FIGS. 4 A & B, the firmness and hardness were increased significantly at the lower adding levels (0.15% and 0.25%), but began to decrease from 0.35% to 0.5% level. The springiness and chewiness showed similar changes to the firmness and hardness. The results also indicated SAPP mainly improved the firmness and hardness at lower level of addition, and no significant difference was found between the levels of 0.15% and 0.25%.

TABLE 5
Firmness and TPA of hard whole wheat pasta by adding SAPP through 4 cycles of freeze-thaw.

| PSs | | | | | | |
|---|---|---|---|---|---|---|
| content % | Firmness | Hardness | Springiness | Cohesiveness | Chewiness | Resilience |
| Control | 351.60 ± 1.59^{ab} | 924.74 ± 6.12^{a} | 0.925 ± 0.003^{b} | 0.504 ± 0.004^{a} | 438.74 ± 10.54^{cd} | 0.227 ± 0.001^{abc} |
| 0.15 | 398.85 ± 2.24^{d} | 998.11 ± 0.64^{d} | 0.930 ± 0.010^{b} | 0.522 ± 0.003^{c} | 398.66 ± 2.58^{b} | 0.232 ± 0.001^{c} |
| 0.25 | 397.07 ± 0.74^{d} | 1003.73 ± 1.89^{d} | 0.900 ± 0.050^{b} | 0.519 ± 0.005^{bc} | 449.24 ± 7.78^{d} | 0.227 ± 0.001^{abc} |
| 0.35 | 361.06 ± 1.33^{c} | 956.06 ± 0.94^{c} | 0.822 ± 0.001^{a} | 0.507 ± 0.001^{ab} | 434.25 ± 4.08^{cd} | 0.224 ± 0.003^{ab} |
| 0.45 | 355.35 ± 2.74^{b} | 943.90 ± 4.46^{b} | 0.810 ± 0.050^{a} | 0.520 ± 0.009^{bc} | 421.56 ± 9.16^{c} | 0.231 ± 0.005^{bc} |
| 0.5 | 348.55 ± 3.4^{a} | 938.13 ± 2.84^{b} | 0.825 ± 0.014^{a} | 0.509 ± 0.005^{ab} | 368.572 ± 5.21^{a} | 0.221 ± 0.002^{a} |

All data are reported as means ± standard deviations.
The different letters after the values in the same column indicate the means is significantly different (p < 0.05).
ns means non-significant.

2.4 Effect of Different Adding Levels of SKMP.

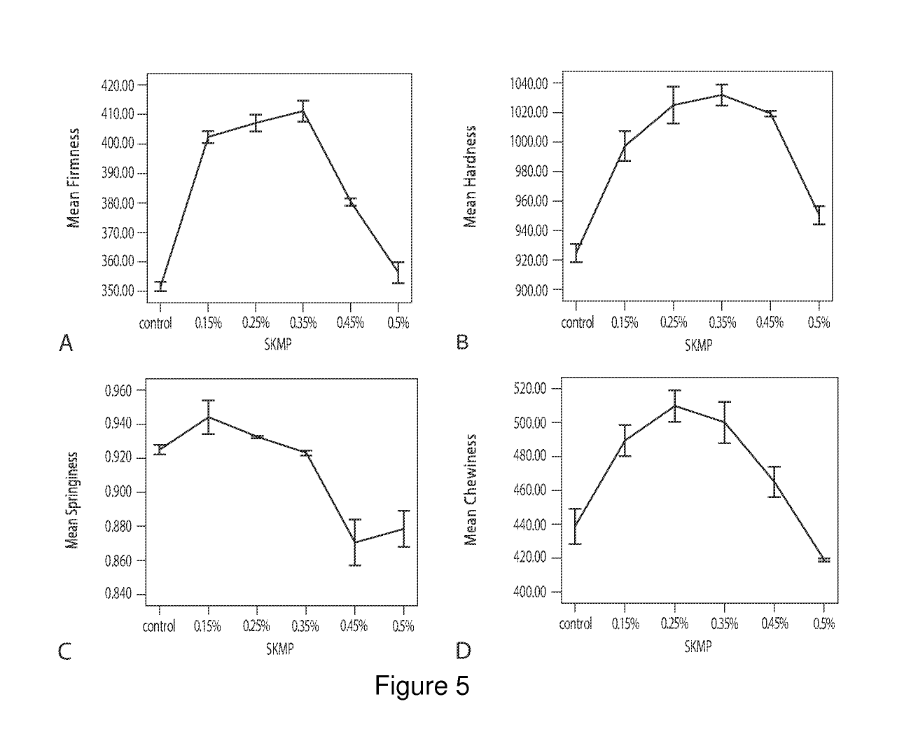

From the addition level of 0.15%, the firmness and hardness values began to increase and reached to the maximum at the level of 0.35%, and then decreased (FIGS. 5 A & B). The springiness and chewiness showed a declining trend generally, as shown in FIGS. 5 C & D. In addition, there was no significant difference of the firmness and hardness between 0.25% and 0.35% addition (Table 6).

TABLE 6
Firmness and TPA of hard whole wheat pasta by adding SKMP after 4 cycles of freeze-thaw.

| PSs | | | | | | |
|---|---|---|---|---|---|---|
| content % | Firmness | Hardness | Springiness | Cohesiveness | Chewiness | Resilience |
| Control | 351.60 ± 1.59^{a} | 924.74 ± 6.12^{a} | 0.925 ± 0.003^{b} | 0.504 ± 0.004^{a} | 438.74 ± 10.54^{a} | 0.227 ± 0.001^{a} |
| 0.15 | 402.35 ± 1.99^{c} | 997.23 ± 10.05^{c} | 0.944 ± 0.009^{b} | 0.525 ± 0.003^{b} | 489.30 ± 9.22^{c} | 0.243 ± 0.001^{bc} |
| 0.25 | 407.09 ± 2.86^{cd} | 1024.97 ± 12.44^{d} | 0.933 ± 0.001^{b} | 0.533 ± 0.004^{b} | 509.69 ± 9.30^{c} | 0.250 ± 0.002^{c} |
| 0.35 | 411.11 ± 3.56^{d} | 1031.79 ± 7.12^{d} | 0.923 ± 0.001^{b} | 0.524 ± 0.003^{b} | 499.99 ± 12.16^{c} | 0.229 ± 0.005^{a} |
| 0.45 | 380.29 ± 1.27^{b} | 1019.2 ± 1.81^{d} | 0.871 ± 0.010^{a} | 0.529 ± 0.001^{b} | 464.96 ± 9.06^{b} | 0.236 ± 0.004^{ab} |
| 0.5 | 356.27 ± 3.58^{a} | 950.38 ± 6.24^{b} | 0.879 ± 0.010^{a} | 0.505 ± 0.005^{a} | 418.92 ± 0.91^{a} | 0.231 ± 0.008^{a} |

All data are reported as means ± standard deviations.
The different letters after the values in the same column indicate the means is significantly different (p < 0.05).
ns means non-significant.

### Example 3

### Reduction of Egg White Usage in Frozen Whole Wheat Pasta with Selected Phosphate Salts (TCP, CAPP, SAPP and SKMP)

3.1 Effect of Phosphate Salt or Blend at Lower Levels of Egg White (1.5%).

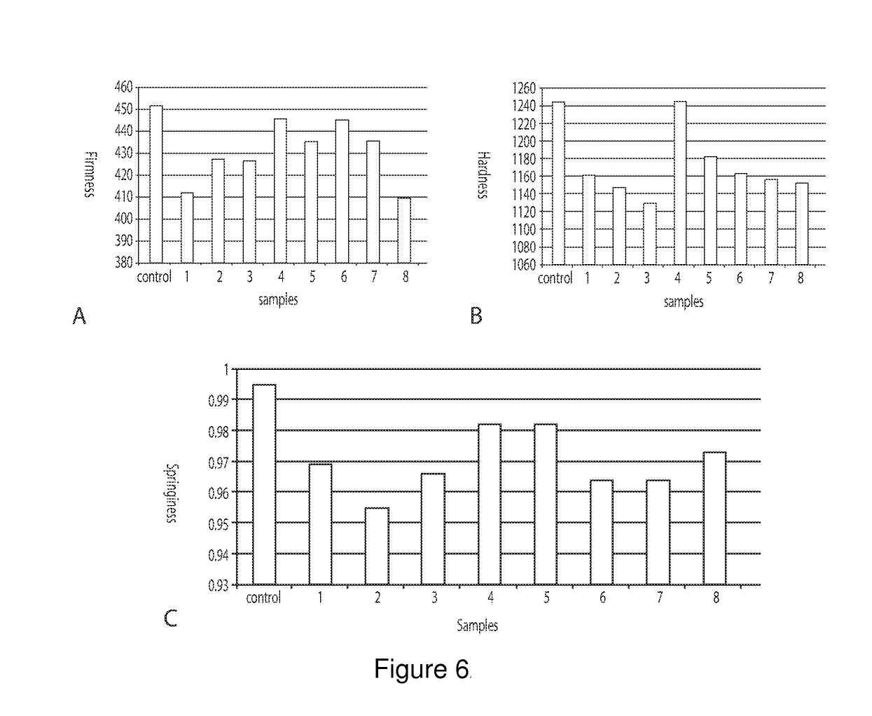

The usage of egg white was reduced to from 2% to 1.5% in frozen whole wheat pasta in this study. Levels of TCP, CAPP, SAPP and SKMP were decided based on the results described previously. The results indicated that the firmness, hardness, springiness and chewiness all reduced for most samples with 1.5% egg white and each of the four phosphate salts at their respective optimal addition levels (FIG. 6). However, the two samples that contained 0.3% CAPP (No. 4) and a blend of three phosphate salts (0.15% SAPP+0.25% SKMP+0.4% TCP) (No. 6) showed no significant difference in firmness values compared to the control (2% egg white, no phosphate salt). As for the hardness, only the No. 4 sample (0.3% CAPP) was slightly higher than the control (Table 7). The springiness of No. 4 (0.3% CAPP) and No. 5 samples (0.4% TCP+0.3% CAPP) was no significant difference from the control. From these results, it can be concluded that the egg white usage level in frozen whole wheat pasta could be reduced from 2% to at least 1.5% by adding 0.3% CAPP.

TABLE 7
Firmness and TPA of hard whole wheat pasta by adding eggwhite (EW) and phosphate salts after 4 cycles of freeze-thaw.

| | Phosphate salts | | | | | | |
|---|---|---|---|---|---|---|---|
| Samples | content % | Firmness | Hardness | Springiness | Cohesiveness | Chewiness | Resilience |
| control | 2% EW (control) | 452.21 ± 6.78^{d} | 1244.57 ± 7.83^{e} | 0.995 ± 0.003^{e} | 0.515 ± 0.004^{b} | 555.70 ± 8.35^{d} | 0.237 ± 0.005^{bc} |
| 1 | 1.5% EW + | 412.44 ± 3.80^{a} | 1162.22 ± 8.68^{bc} | 0.969 ± 0.012^{bcd} | 0.535 ± 0.002^{e} | 537.23 ± 3.00^{c} | 0.250 ± 0.001^{d} |
| | 0.25% SKMP | | | | | | |
| 2 | 1.5% EW + | 427.44 ± 4.49^{b} | 1147.53 ± 9.97^{b} | 0.955 ± 0.004^{ab} | 0.520 ± 0.003^{bc} | 539.78 ± 7.38^{c} | 0.238 ± 0.001^{bc} |
| | 0.15% SAPP | | | | | | |
| 3 | 1.5% EW + | 426.63 ± 1.70^{b} | 1129.73 ± 5.40^{a} | 0.966 ± 0.001^{abcd} | 0.532 ± 0.002^{de} | 555.41 ± 2.17^{d} | 0.242 ± 0.004^{c} |
| | 0.4% TCP | | | | | | |
| 4 | 1.5% EW + | 445.97 ± 1.84^{cd} | 1245.32 ± 3.25^{e} | 0.982 ± 0.005^{de} | 0.526 ± 0.003^{cd} | 555.28 ± 10.02^{d} | 0.242 ± 0.001^{c} |
| | 0.3% CAPP | | | | | | |
| 5 | 1.5% EW + | 435.75 ± 0.55^{bc} | 1183.01 ± 3.06^{d} | 0.982 ± 0.006^{de} | 0.515 ± 0.002^{b} | 505.03 ± 1.35^{b} | 0.234 ± 0.002^{b} |
| | 0.4% TCP + | | | | | | |
| | 0.3% CAPP | | | | | | |
| 6 | 1.5% EW + | 445.63 ± 7.25^{cd} | 1163.82 ± 4.32^{c} | 0.951 ± 0.004^{a} | 0.506 ± 0.007^{a} | 509.13 ± 5.86^{b} | 0.223 ± 0.021^{a} |
| | 0.25% SKMP + | | | | | | |
| | 0.15% SAPP + | | | | | | |
| | 0.4% TCP | | | | | | |
| 7 | 1.5% EW + | 435.89 ± 4.72^{bc} | 1156.45 ± 3.97^{bc} | 0.964 ± 0.008^{abc} | 0.501 ± 0.002^{a} | 487.93 ± 5.47^{a} | 0.227 ± 0.001^{a} |
| | 0.25% SKMP + | | | | | | |
| | 0.15% SAPP + | | | | | | |
| | 0.3% CAPP | | | | | | |
| 8 | 1.5% EW + | 409.73 ± 1.67^{a} | 1152.38 ± 4.72^{bc} | 0.973 ± 0.017^{cd} | 0.505 ± 0.002^{a} | 513.26 ± 8.13^{b} | 0.224 ± 0.001^{a} |
| | 0.25% SKMP + | | | | | | |
| | 0.15% SAPP + | | | | | | |
| | 0.4% TCP + | | | | | | |
| | 0.3% CAPP | | | | | | |

All data are reported as means ± standard deviations.
The different letters after the values in the same column indicate the means is significantly different (p < 0.05).
ns means non-significant.

3.2 Effect of 0.3% CAPP Addition on the Textural Properties of Frozen Hard Whole Wheat Pasta with Varied Contents of Egg White.

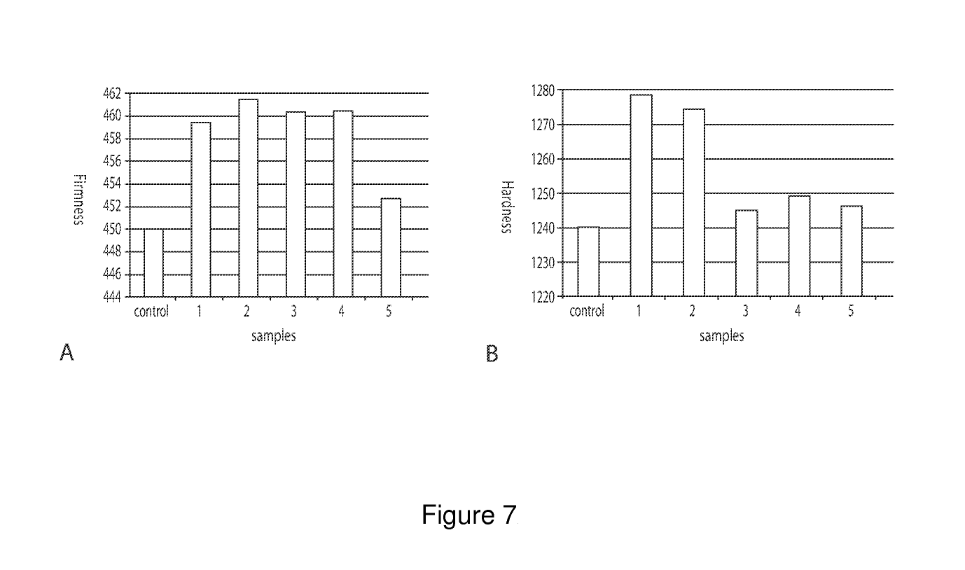

As the content of egg white was reduced from 1.9% (No. 1) to 1.6% (No. 4), the firmness was still significantly higher than the control by adding 0.3% CAPP (Table 8 and FIG. 7), but there was no significant difference from the control when the content of egg white was further decreased to 1.5%. The samples (No. 1 and 2) with 1.9% and 1.8% levels of egg white, respectively, were higher than the control in hardness; however as the content further decreased (from 1.7% to 1.5%), the difference from the control disappeared (Table 8, FIG. 7). At the same time, the springiness became smaller than the control as the egg white level was decreased, but the chewiness and resilience appeared to show no significant change.

TABLE 8
Firmness and TPA of whole wheat pasta by adding varied egg white (EW) and 0.3% CAPP after 4 cycles of freeze-thaw.

| Samples | Eggwhite content % | Firmness | Hardness | Springiness | Cohesiveness | Chewiness^{ns} | Resilience^{ns} |
|---|---|---|---|---|---|---|---|
| control | 2% EW (control) | 450.09 ± 4.10^{a} | 1239.92 ± 6.35^{a} | 1.022 ± 0.041^{b} | 0.519 ± 0.001^{a} | 563.87 ± 8.14 | 0.242 ± 0.001 |
| 1 | 1.9% EW + 0.3% CAPP | 459.44 ± 7.80^{bc} | 1278.69 ± 5.42^{b} | 0.989 ± 0.009^{ab} | 0.522 ± 0.006^{ab} | 556.75 ± 6.01 | 0.242 ± 0.005 |
| 2 | 1.8% EW + 0.3% CAPP | 461.51 ± 7.00^{c} | 1274.29 ± 16.43^{b} | 0.971 ± 0.004^{a} | 0.530 ± 0.001^{b} | 557.59 ± 10.21 | 0.238 ± 0.005 |
| 3 | 1.7% EW + 0.3% CAPP | 460.37 ± 1.85^{bc} | 1244.82 ± 1.27^{a} | 0.979 ± 0.002^{ab} | 0.522 ± 0.005^{ab} | 549.40 ± 4.50 | 0.238 ± 0.001 |
| 4 | 1.6% EW + 0.3% CAPP | 460.46 ± 2.82^{bc} | 1249.03 ± 2.72^{a} | 0.984 ± 0.003^{ab} | 0.521 ± 0.001^{ab} | 557.58 ± 6.83 | 0.237 ± 0.003 |
| 5 | 1.5% EW + 0.3% CAPP | 452.73 ± 6.58^{ab} | 1246.19 ± 3.10^{a} | 0.976 ± 0.001^{a} | 0.518 ± 0.004^{a} | 557.56 ± 1.58 | 0.241 ± 0.001 |

All data are reported as means ± standard deviations.
The different letters after the values in the same column indicate the means is significantly different (p < 0.05).
ns means non-significant.

### Example 4

### Effects of Four Selected Phosphate Salts (TCP, CAPP, SAPP and SKMP) on the Cooking Properties (Cooking Yield and Cooking Loss) of Fresh Whole Wheat Pasta

4.1 Effects of Four Selected Phosphate Salts (TCP, CAPP, SAPP and SKMP) on the Cooking Properties

TABLE 9
Cooking yield and cooking loss of fresh
whole wheat pasta by adding TCP.

| No. | PS content % | Cooking yield % ^{ns} | Cooking loss % |
|---|---|---|---|
| 1 | Control | 110.39 ± 0.68 | 6.01 ± 0.08^{c} |
| 2 | 0.15 | 110.87 ± 0.37 | 6.01 ± 0.01^{c} |
| 3 | 0.25 | 110.50 ± 0.73 | 5.78 ± 0.06^{b} |
| 4 | 0.35 | 110.86 ± 0.43 | 5.60 ± 0.01^{a} |
| 5 | 0.40 | 110.28 ± 0.55 | 5.51 ± 0.07^{a} |
| 6 | 0.50 | 109.93 ± 0.21 | 5.48 ± 0.06^{a} |

All data are reported as means ± standard deviations. The different letters after the values in the same column indicate the means is significantly different (p < 0.05).
^{ns} means non-significant.

From the Table 9, the cooking loss was found to decrease as the addition level of TCP increased. The difference of cooking loss became significant at the additional levels from 0.25% to 0.5%, but the cooking yield didn't show significant change.

TABLE 10
Cooking yield and cooking loss of fresh
whole wheat pasta by adding CAPP.

| No. | PS content % | Cooking yield % ^{ns} | Cooking loss % |
|---|---|---|---|
| 1 | Control | 110.39 ± 0.68 | 6.01 ± 0.08^{b} |
| 2 | 0.15 | 111.78 ± 0.57 | 5.97 ± 0.09^{ab} |
| 3 | 0.25 | 110.78 ± 0.92 | 6.15 ± 0.13^{b} |
| 4 | 0.30 | 110.14 ± 1.45 | 6.07 ± 0.09^{b} |
| 5 | 0.35 | 110.74 ± 0.35 | 5.96 ± 0.18^{ab} |
| 6 | 0.50 | 110.23 ± 0.18 | 5.68 ± 0.16^{a} |

All data are reported as means ± standard deviations. The different letters after the values in the same column indicate the means is significantly different (p < 0.05).
^{ns} means non-significant.

The addition of CAPP did not significantly affect the cooking loss except for at 0.5% addition level as shown in Table 10. The difference of cooking yield was still not significant compared with the control.

TABLE 11
Cooking yield and cooking loss of fresh
whole wheat pasta by adding SAPP.

| | Phosphate salts | | |
|---|---|---|---|
| No. | content % | Cooking yield % | Cooking loss % ^{ns} |
| 1 | Control | 110.39 ± 0.68^{c} | 6.01 ± 0.08 |
| 2 | 0.15 | 110.83 ± 0.28^{c} | 5.83 ± 0.13 |
| 3 | 0.25 | 106.62 ± 0.31^{b} | 5.83 ± 0.26 |
| 4 | 0.35 | 105.93 ± 0.12^{b} | 6.07 ± 0.07 |
| 5 | 0.45 | 103.07 ± 0.56^{a} | 6.08 ± 0.14 |
| 6 | 0.50 | 102.68 ± 0.48^{a} | 6.13 ± 0.04 |

All data are reported as means ± standard deviations. The different letters after the values in the same column indicate the means is significantly different (p < 0.05).
^{ns} means non-significant.

For SAPP, the cooking yield decreased as the addition level increased from 0.25 to 0.5%, but cooking loss did not change (Table 11).

TABLE 12
Cooking yield and cooking loss of fresh
whole wheat pasta by adding SKMP.

| | Phosphate salts | | |
|---|---|---|---|
| No. | content % | Cooking yield % | Cooking loss % ^{ns} |
| 1 | Control | 110.39 ± 0.68^{c} | 6.01 ± 0.08 |
| 2 | 0.15 | 110.62 ± 0.30^{c} | 6.13 ± 0.12 |
| 3 | 0.25 | 109.03 ± 0.44^{b} | 6.09 ± 0.11 |
| 4 | 0.35 | 108.33 ± 0.30^{b} | 6.00 ± 0.04 |
| 5 | 0.45 | 105.93 ± 0.58^{a} | 5.91 ± 0.18 |
| 6 | 0.50 | 104.99 ± 0.17^{a} | 5.89 ± 0.05 |

All data are reported as means ± standard deviations. The different letters after the values in the same column indicate the means is significantly different (p < 0.05).
^{ns} means non-significant.

The cooking yield was significantly decreased as the addition level of SKMP increased from 0.25% to 0.5%, while the cooking loss was not affected (Table 12).

4.2 Effect of Varied Phosphate Salts on the Cooking Properties of Whole Wheat Pasta with 1.5% Egg White.

Different types of phosphate salts had varied effects on the cooking properties of whole wheat pasta with 1.5% egg white. The cooking yield of the pasta by adding 0.25% SKMP was significantly higher than that of the control, however it was significantly lower by adding 0.3% CAPP and a blend (0.25% SKMP+0.15% SAPP+0.3% CAPP), respectively. The other phosphate salts or the blends showed no significant effect on the cooking yield (Table 13). Most of phosphate salts significantly increased the cooking loss except for CAPP.

TABLE 13
The cooking yield and cooking loss of whole wheat pasta
with 1.5% egg white by adding phosphate salts.

| No. | Phosphate salts % | Cooking yield % | Cooking loss % |
|---|---|---|---|
| 1 | 2% EW (control) | 108.25 ± 0.07^{c} | 5.21 ± 0.13^{a} |
| 2 | 1.5% EW + 0.25% SKMP | 109.38 ± 0.72^{d} | 5.73 ± 0.43^{bc} |
| 3 | 1.5% EW + 0.15% SAPP | 109.08 ± 0.20^{cd} | 5.71 ± 0.23^{bc} |
| 4 | 1.5% EW + 0.4% TCP | 109.03 ± 0.03^{cd} | 5.34 ± 0.08^{ab} |
| 5 | 1.5% EW + 0.3% CAPP | 104.54 ± 0.86^{a} | 5.06 ± 0.11^{a} |
| 6 | 1.5% EW + 0.25% SKMP + | 109.02 ± 0.23^{cd} | 6.14 ± 0.11^{c} |
| | 0.15% SAPP + 0.4% TCP | | |
| 7 | 1.5% EW + 0.25% SKMP + | 105.82 ± 0.80^{b} | 5.85 ± 0.80^{c} |
| | 0.15% SAPP + 0.3% CAPP | | |

All data are reported as means ± standard deviations. The different letters after the values in the same column indicate the means is significantly different (p < 0.05). ns means non-significant.

Both the type and additional level of phosphate salts had varied effect on the textural stability of frozen whole wheat pasta. In particular, four phosphate salts including TCP, CAPP, SAPP and SKMP were shown to be effective, and their optimal addition levels in these tests were 0.5%, 0.3%, 0.15%, and 0.25% respectively. At the 1.5% addition level of egg white, TCP, CAPP, SAPP and SKMP and their partial blends showed different effects on the textural stability of frozen whole wheat pasta when compared with the control (with 2% egg white), and 0.3% CAPP in particular was shown to be effective in improving firmness and hardness. The four phosphate salts and their blends also showed varied effects on the cooking properties.

### Example 5

### Representative Pasta Formulations and Procedures

I. Formulation

a. Whole wheat pasta

Whole wheat flour blend: 100%
Hard whole wheat flour: 51%
Semolina (14% mb): 49%

Phosphate salts: (according to treatments)

Dried egg white: 0-2%

Water: 32.5%

b. Regular pasta

Semolina (14% mb): 100%

Phosphate salts: (according to treatments)

Water: 28.5%

(note: all ingredients are based on the percentage of flour)

II. Procedure

a. Blend Preparation

1. Dissolve phosphate salt in the pre-weighed tap water;

2. Weigh hard whole wheat flour and semolina and blend them in plastic bag;

3. Weigh egg white and mix with the flour blend in the plastic bag.

b. Mixing

1. Pour flour/egg white blend into the mixing bowl and start the pasta machine (P3 automatic fresh pasta machine, La Monferrina snc., ASTI, Italy);

2. Slowly pour phosphate solution into the mixing bowl (stir and suspend the solution while pouring if phosphate salt is insoluble);

3. Stop to clean the beater after mixing for 1 and 10 min., respectively;

4. Continue to mix for another 5 min (total 15 min mixing time).

c. Kneading and extruding

1. Start the machine to knead the dough and extrude into spaghetti using the 1.7-mm diameter die.

2. After extruding for 40 s, cut the extruded spaghetti strands to 8-cm long, and store in plastic bag and seal it for further test.

d. Cooking and Rinsing

1. Weigh 100 g fresh pasta and cook for 10 min in a boiling water bath;

2. Rinse the cooked pasta in 25° C. water and then 6° C. water for 1 min each;

3. Drain rinsed pasta in a plastic strainer by tapping the strainer forcefully for 15 times (about 15 s) on the edge of a sink;

4. Divide the pasta into two equal portions and place them into two plastic boxes.

e. Freezing

1. Freeze the pastas at −40° C. for 30 min in a blast freezer (Model: ESX-2CW, Espec Inc., Hudsonville, Mich., USA) until core temperature is −17° C.;

2. Take out the frozen pasta, place in freezer bag, and store at −18° C. storage freezer for further test.

f. Freeze/Thaw Cycle

1. After freezer storage for 5 days, take out the product and thaw at room temperature (22° C.) for 1 hour then return the pasta into storage freezer to complete 1st cycle of freeze-thaw;

2. After 5 days of freezer storage, take out, thaw at room temperature (22° C.) for 1 hr and return to the storage freezer (2nd cycle);

3. After 5 days of freezer storage, take out, thaw at room temperature (22° C.) for 1 hr and return to the storage freezer (3rd cycle);

4. After 3 days of freezer storage, take out, thaw at room temperature (22° C.) for 2 hrs, cook for 1 min in a boiling bath, and perform textural measurements.

### Example 6

### 1. Effect of Phosphate Salts on the Textural Stability of Soaked Whole Wheat Pasta (Soaking in 50° C. Cold Water for 30 Seconds and in 100° C. For 5 to 30 min.)

Table 14 shows 0.25% SAPP was effective in maintaining the firmness stability of cooked pasta during soaking for 10-30 min.

Table 15 shows 0.25% SAPP was most effective in maintaining the hardness stability of cooked pasta during soaking for 5-10 min. 0.4% TCP also showed effectiveness after soaking for 10-15 min.

TABLE 14
Firmness of hard whole wheat pasta* by adding four types of phosphate salts and soaking for up to 30 minutes after cooking.

| | Phosphate | | | | | | |
|---|---|---|---|---|---|---|---|
| | salts | | | | | | |
| No. | content | 5 min | 10 min | 15 min | 20 min | 25 min | 30 min |
| 1 | Control | 626.11 ± 11.65^{ab} | 613.51 ± 12.20^{a} | 600.10 ± 31.21^{a} | 580.04 ± 12.28^{a} | 548.13 ± 13.19^{a} | 529.43 ± 3.22^{a} |
| 2 | 0.4% TCP | 613.71 ± 4.59^{a} | 629.52 ± 1.34^{a} | 599.41 ± 12.98^{a} | 579.33 ± 1.45^{a} | 567.47 ± 5.37^{ab} | 548.09 ± 3.75^{b} |
| 3 | 0.3% CAPP | 627.77 ± 5.48^{ab} | 630.46 ± 6.24^{ab} | 591.24 ± 2.14^{a} | 576.13 ± 3.20^{a} | 556.80 ± 1.93^{a} | 545.07 ± 3.01^{b} |
| 4 | 0.25% SAPP | 658.56 ± 21.87^{b} | 650.74 ± 10.66^{b} | 636.98 ± 5.87^{b} | 605.31 ± 10.71^{b} | 585.49 ± 15.82^{b} | 559.81 ± 4.76^{c} |
| 5 | 0.35% SKMP | 626.17 ± 6.36^{ab} | 631.40 ± 2.48^{ab} | 603.09 ± 2.84^{a} | 585.94 ± 3.74^{a} | 560.68 ± 6.90^{ab} | 546.56 ± 1.84^{b} |

All data are reported as means ± standard deviations.
The different letters after the values in the same column indicate the means is significantly different (p < 0.05).
ns means non-significant.
*Formula: flour (51% whole HW flour/49% semolina), 100%; water, 32.5%; phosphate (varied amount).

TABLE 15
Hardness of hard whole wheat pasta* by adding four types of phosphate salts and soaking for 30 minutes after cooking.

| | Phosphate | | | | | | |
|---|---|---|---|---|---|---|---|
| | salts | | | | | | |
| No. | content | 5 min | 10 min | 15 min | 20 min | 25 min | 30 min |
| 1 | Control | 1259.78 ± 2.96^{b} | 1254.69 ± 5.83^{b} | 1243.37 ± 5.30^{b} | 1231.81 ± 5.40^{ab} | 1225.33 ± 18.22^{a} | 1211.98 ± 7.69^{b} |
| 2 | 0.4% TCP | 1274.16 ± 8.14^{bc} | 1275.10 ± 2.13^{c} | 1287.61 ± 1.55^{c} | 1252.19 ± 9.62^{bc} | 1225.23 ± 2.64^{a} | 1232.01 ± 2.59^{c} |
| 3 | 0.3% CAPP | 1292.19 ± 6.00^{c} | 1257.34 ± 5.37^{bc} | 1246.77 ± 2.33^{b} | 1246.96 ± 5.83^{bc} | 1227.24 ± 6.97^{a} | 1220.46 ± 6.79^{bc} |
| 4 | 0.25% SAPP | 1319.15 ± 10.22^{d} | 1303.27 ± 11.99^{d} | 1295.61 ± 25.89^{c} | 1287.44 ± 25.77^{c} | 1270.79 ± 19.96^{b} | 1231.28 ± 5.60^{c} |
| 5 | 0.35% SKMP | 1222.52 ± 14.28^{a} | 1214.97 ± 4.11^{a} | 1191.22 ± 1.37^{a} | 1194.41 ± 1.10^{a} | 1192.30 ± 3.50^{a} | 1194.66 ± 9.69^{a} |

All data are reported as means ± standard deviations.
The different letters after the values in the same column indicate the means is significantly different (p < 0.05).
ns means non-significant.
*Formula: flour (51% whole HW flour/49% semolina), 100%; water, 32.5%; phosphate (varied amount).

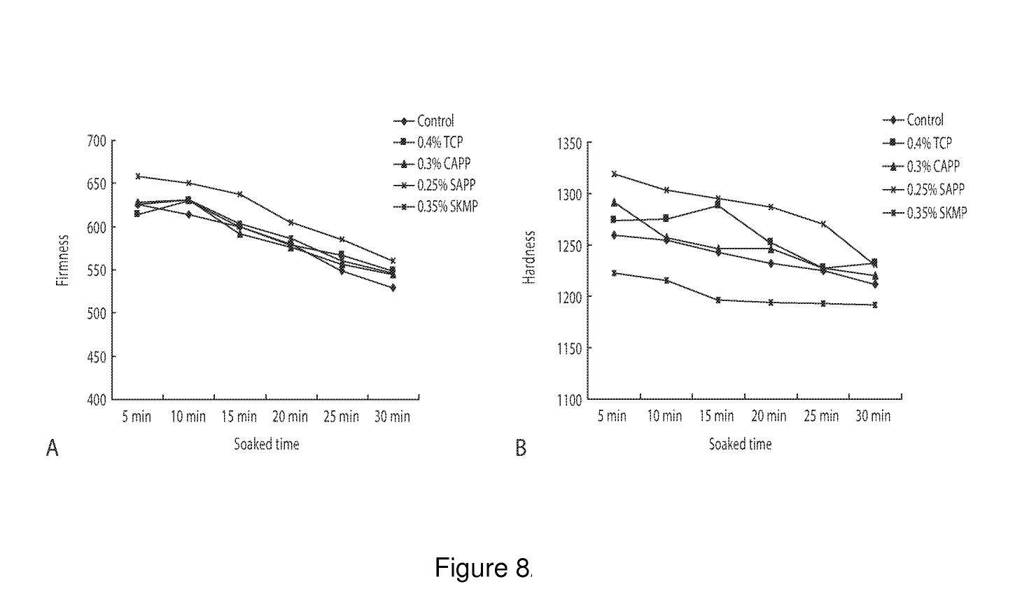

FIG. 8 shows that both firmness and hardness of cooked whole wheat pasta decreased after soaking for 5-30 min; however, pastas containing 0.25% SAPP had significantly higher hardness and firmness values than other samples.

### 2. The Effect of Phosphate Salts on the Frozen Semolina Pasta

TABLE 16
The firmness and TPA of whole semolina pasta by adding selected PSs after 4 cycles of freeze-thaw.

| | | | | Cohesiveness | | Resilience |
|---|---|---|---|---|---|---|
| PSs content % | Firmness | Hardness | Springiness | ns | Chewiness | ns |
| Control | 490.74 ± 2.95^{c} | 1049.09 ± 12.31^{a} | 0.936 ± 0.003^{a} | 0.609 ± 0.006 | 599.4 ± 8.12^{b} | 0.301 ± 0.004 |
| 0.4% TCP | 497.67 ± 1.76^{c} | 1084.42 ± 7.16^{b} | 0.95 ± 0.004^{b} | 0.612 ± 0.007 | 634.39 ± 3.61^{d} | 0.303 ± 0.005 |
| 0.3% CAPP | 498.43 ± 4.00^{c} | 1092.6 ± 7.52^{b} | 0.95 ± 0.003^{b} | 0.603 ± 0.004 | 616.72 ± 3.98^{c} | 0.307 ± 0.001 |
| 0.25% SKMP | 454.58 ± 4.81^{a} | 1033.78 ± 7.11^{a} | 0.929 ± 0.008^{a} | 0.600 ± 0.002 | 578.62 ± 11.86^{a} | 0.299 ± 0.002 |
| 0.15% SAPP | 467.77 ± 3.19^{b} | 1049.33 ± 9.27^{a} | 0.946 ± 0.004^{b} | 0.604 ± 0.002 | 588.06 ± 3.74^{ab} | 0.307 ± 0.009 |

All data are reported as means ± standard deviations.
The different letters after the values in the same column indicate the means is significantly different (p < 0.05).
ns means non-significant.

From Table 16, 0.4% TCP and 0.3% CAPP were found to have significant effect on the stability of hardness, springiness and chewiness of frozen whole semolina pasta, except cohesiveness and resilience. As for firmness, the two PSs didn't show more effectiveness than the control. In this research, SKMP and SAPP did not necessarily improve the textural stability of frozen whole semolina pasta.

### Example 7

In this representative example, frozen pastas were subjected to four cycles of freeze-thaw during 17 days. The results indicated that most of phosphate salts (“PSs”) could improve the textual stability at the addition level of 0.25% compared to the control, but TCP, CAPP, SAPP and SKMP showed more effectiveness than other PSs. The effect of different addition levels of the four PSs was also investigated, and the results showed that 0.4%, 0.3%, 0.15% and 0.25% could be considered the optimal addition levels for TCP, CAPP, SAPP and SKMP, respectively. As for the effect of blends of CAPP, TCP and SAPP, the results indicated four types of PSs blends were confirmed to be more effective on the textural stability of whole wheat frozen pasta than others, which were 0.3% CAPP+0.2% TCP, 0.1% CAPP+0.4% TCP, 0.2% CAPP+0.4% TCP and 0.2% CAPP+0.3% TCP respectively.

Through analyzing both the firmness and hardness of whole wheat frozen pasta, the negative effect on textural stability because of reducing the egg white content from 2% to 1.5% could be significantly decreased by adding 0.3% CAPP. As for the textural stability of soaked whole wheat pasta, however, 0.25% SAPP and 0.4% TCP showed more positive effect than CAPP and SKMP. These results indicated varied effects of PSs on the textural stability for the different treatments of the pasta.

The cooking loss decreased as the addition of TCP and CAPP was increased, but the cooking yield had no significant change. The SAPP and SKMP caused the decrease of cooking yield as the addition level increased, but had no effect on the cooking loss. As for the mixolab properties, the stability time, C2 and C4 time of mixolab were improved by adding 0.25% of each TCP, CAPP, SAPP and SKMP, which was more effective than the 0.5% level of each of the four PS.

As for the whole semolina pasta, the four selected PSs also showed varied effectiveness on the textural stability and cooking properties. The addition of 0.4% TCP or 0.3% CAPP could significantly improve the stability of hardness, springiness and chewiness, but had no effect on the firmness stability. In addition, TCP, CAPP and SAPP were more effective on the decrease of cooking loss of whole semolina pasta than SKMP.

### 1. Materials and Methods

### 1.1 Materials

The semolina and hard white whole wheat flour were provided by ConAgra Mills (Nebraska, USA). The egg white used is a commercial product with 100% dried egg whites (Just Whites, Deb-El Foods Corporation, 2 Papetti Plaza, Elizabeth, N.J. 07206) stored at 4° C. Twelve types of PSs were supplied by ICL Performance Products LP (St. Louis, Mo.).

### 1.2 Methods

### 1.2.1 Making Fresh Hard Whole Wheat Pasta and Whole Semolina Pasta

The spaghetti was made by the P3 automatic fresh pasta machine (Imperia & Monferrina, Italy) using the whole wheat flour and pasta blend (51% hard white whole wheat flour and 49% semolina) according the method described by the technical manual. The die diameter for spaghetti was 1.7 mm in this research. The fresh spaghetti strands were cut into 8.0 cm in length for further experiments.

### 1.2.2 Cooking Fresh Pasta and Freezing the Cooked Pasta

Fresh pasta strands (100 g) were cooked in the boiling water until the white core of pasta disappeared; the cooking time was recorded as the optimal time. In this research, the optimal time was 10 min for fresh pasta.

The cooked pasta was rinsed in 25° C. water for 1 min and cooled in 5° C. water for 1 min. The cooled pasta was blast frozen at −40° C. for 35 minutes and stored at −18° C. The frozen pasta was taken out to thaw at room temperature for 1 hour after 5 days, and stored at −18° C. again. This cycle was repeated for three times in 15 days. After the thaw of the last cycle, the pasta was stored at −18° C. for 2 days and thawed at room temperature for 2 hours for textural analysis. In summary, the cooked pasta was treated for 4 times of freeze-thaw (in total 17 days) before being tested.

### 1.2.3 Soaking the Hard Whole Wheat Pasta

The cooked pasta was first cooled in 5° C. water for 30 seconds and then transferred into 10° C. water for 30 min. The firmness and TPA were tested at 5 min, 10 min, 15 min, 20 min, 25 min and 30 min, respectively.

### 1.2.4 Determination of Firmness, TPA and Mixolab Properties

The determination of firmness was according to the AACC International Approved Method (AACC method 66-50.01, 1999) and the method described by Sissons et al. (2008) with minor modification. The fresh pasta was cooked for 10 min (and 1 min for frozen pasta after being thawed at room temperature for 2 hours) and then rinsed in 25° C. for 2 min, and drained the water by tapping the strainer 10 times. The drained pasta was rested at 25° C. for 1 min for the determination of firmness.

The TPA properties including hardness, springiness, cohesiveness, chewiness and resilience were determined using the method described by Hou (2010b). The fresh pasta was cooked for 10 min (1 min for frozen pasta after being thawed at room temperature for 2 hours) and then rinsed in 25° C. for 1 min, and drained the water by tapping the strainer 10 times for the determination of TPA. The cooking yield and loss were also according to the methods described by Hou (2010b). The mixolab indexes were determined based on the technical manual using the flour blend of hard whole wheat (51%) and semolina (49%).

### 2.4 Study on the Effect of Selected PSs Blends on the Whole Wheat Frozen Pasta Textural Stability.

In this research, adding 0.25% SKMP showed no positive effect on the textural stability of frozen whole wheat pasta made from hard whole wheat flour and the new semolina, comparing with the control (data not shown). Therefore, three other PSs were selected for researching the effect of their blends on the frozen whole wheat pasta, which were CAPP with four levels of addition (0, 0.1%, 0.2% and 0.3%), TCP with four levels (0, 0.2%, 0.3% and 0.4%) and SAPP with three levels (0, 0.15% and 0.25%), respectively. According to the orthogonal experiment, 23 types of blends were obtained, as shown in Table 17.

TABLE 17
The orthogonal experiment for whole wheat frozen pasta by adding
varied types blend of PSs after 4 cycles of freeze-thaw.

| | PSs blend types | |
|---|---|---|
| No. | CAPP-TCP-SAPP | Addition levels of PSs of each type |
| 1 | 0-0-0 | 0 |
| 2 | 3-0-0 | 0.3% CAPP |
| 3 | 0-3-0 | 0.4% TCP |
| 4 | 0-0-2 | 0.25% SAPP |
| 5 | 3-1-2 | 0.3% CAPP + 0.2% TCP + 0.25% SAPP |
| 6 | 1-3-2 | 0.1% CAPP + 0.4% TCP + 0.25% SAPP |
| 7 | 1-2-2 | 0.1% CAPP + 0.3% TCP + 0.25% SAPP |
| 8 | 3-3-1 | 0.3% CAPP + 0.4% TCP + 0.15% SAPP |
| 9 | 2-3-1 | 0.2% CAPP + 0.4% TCP + 0.15% SAPP |
| 10 | 3-2-1 | 0.3% CAPP + 0.3% TCP + 0.15% SAPP |
| 11 | 2-2-1 | 0.2% CAPP + 0.3% TCP + 0.15% SAPP |
| 12 | 1-1-1 | 0.1% CAPP + 0.2% TCP + 0.15% SAPP |
| 13 | 3-1-1 | 0.3% CAPP + 0.2% TCP + 0.15% SAPP |
| 14 | 3-3-2 | 0.3% CAPP + 0.4% TCP + 0.25% SAPP |
| 15 | 1-3-1 | 0.1% CAPP + 0.4% TCP + 0.15% SAPP |
| 16 | 2-1-1 | 0.2% CAPP + 0.2% TCP + 0.15% SAPP |
| 17 | 1-3-0 | 0.1% CAPP + 0.4% TCP |
| 18 | 2-3-0 | 0.2% CAPP + 0.4% TCP |
| 19 | 2-2-0 | 0.2% CAPP + 0.3% TCP |
| 20 | 0-3-2 | 0.4% TCP + 0.25% SAPP |
| 21 | 0-3-1 | 0.4% TCP + 0.15% SAPP |
| 22 | 3-1-0 | 0.3% CAPP + 0.2% TCP |
| 23 | 3-2-0 | 0.3% CAPP + 0.3% TCP |

The results indicated that four types of PSs blends (1-3-0, 2-3-0, 2-2-0 and 3-1-0) were more effective on the textural stability of whole wheat frozen pasta than other PSs blends, as shown in Table 18. As for the addition of individual PS, such as CAPP, TCP and SAPP, there was still some effectiveness on the firmness stability of the frozen pasta. On the other hand, the blends with the three PSs all did not show significant improvement on the textural stability of frozen pasta.

In conclusion, four blends of CAPP/TCP (0.1% CAPP+0.4% TCP; 0.2% CAPP+0.4% TCP; 0.2% CAPP+0.3% TCP; and 0.3% CAPP+0.2% TCP) could be considered more effective than individual PS and other PSs blends on the textural stability of frozen whole wheat pasta.

TABLE 18
The firmness and TPA of whole semolina pasta by adding varied types combination of PSs after 4 cycles of freeze-thaw.

| Phosphate blends | Firmness | Hardness | Springiness | Cohesiveness | Chewiness | Resilience |
|---|---|---|---|---|---|---|
| 0-0-0 | 387.2 ± 9.79^{cdef} | 956.93 ± 6.11^{abc} | 0.928 ± 0.014^{abcde} | 0.545 ± 0.006^{defgh} | 487.81 ± 15.44^{bcdef} | 0.247 ± 0.007^{abcd} |
| 3-0-0 | 400.1 ± 3.75^{efgh} | 943.76 ± 1.99^{a} | 0.926 ± 0.003^{abcde} | 0.545 ± 0.001^{defgh} | 476.83 ± 4.69^{abcd} | 0.247 ± 0.003^{abcd} |
| 0-3-0 | 407.39 ± 8.24^{fgh} | 959.67 ± 12.89^{abc} | 0.930 ± 0.005^{abcde} | 0.556 ± 0.003^{j} | 497.89 ± 13.37^{cdefg} | 0.253 ± 0.002^{bcde} |
| 0-0-2 | 395.66 ± 1.77^{defgh} | 956.76 ± 10.13^{abc} | 0.939 ± 0.011^{cde} | 0.548 ± 0.003^{efghij} | 500.08 ± 15.6^{defg} | 0.256 ± 0.001^{de} |
| 3-1-2 | 376 ± 7.98^{abcd} | 948.66 ± 7.14^{ab} | 0.916 ± 0.006^{ab} | 0.528 ± 0.003^{a} | 459.53 ± 11.17^{ab} | 0.242 ± 0.009^{a} |
| 1-3-2 | 373.71 ± 2.50^{abc} | 972.07 ± 1.27^{abc} | 0.929 ± 0.004^{abcde} | 0.533 ± 0.001^{abc} | 477.04 ± 0.71^{abcd} | 0.244 ± 0.001^{ab} |
| 1-2-2 | 365.31 ± 1.17^{ab} | 975.43 ± 14.42^{abc} | 0.928 ± 0.003^{abcde} | 0.54 ± 0.006^{bcde} | 489.11 ± 8.78^{bcdef} | 0.243 ± 0.004^{ab} |
| 3-3-1 | 381.73 ± 2.56^{bcde} | 964.97 ± 6.55^{abc} | 0.929 ± 0.02^{abcde} | 0.541 ± 0.006^{bcdef} | 486.55 ± 7.22^{abcdef} | 0.243 ± 0.004^{ab} |
| 2-3-1 | 395.98 ± 4.29^{defgh} | 970.51 ± 18.54^{abc} | 0.926 ± 0.009^{abcde} | 0.542 ± 0.002^{cdefg} | 489.08 ± 19.96^{bcdef} | 0.251 ± 0.006^{abcde} |
| 3-2-1 | 370.87 ± 1.75^{abc} | 968.79 ± 8.6^{abc} | 0.925 ± 0.001^{abcd} | 0.533 ± 0.002^{ab} | 469.53 ± 9.07^{abc} | 0.242 ± 0.004^{a} |
| 2-2-1 | 355.54 ± 2.94^{a} | 947.42 ± 4.33^{ab} | 0.919 ± 0.012^{abc} | 0.547 ± 0.004^{defghi} | 478.67 ± 5.87^{abcd} | 0.249 ± 0.001^{abcde} |
| 1-1-1 | 376.14 ± 13.07^{abcd} | 954.44 ± 3.04^{abc} | 0.933 ± 0.011^{abcde} | 0.539 ± 0.002^{bcde} | 457.76 ± 20.84^{a} | 0.246 ± 0.002^{abc} |
| 3-1-1 | 389.26 ± 9.16^{cdefg} | 963.04 ± 12.28^{abc} | 0.929 ± 0.007^{abcde} | 0.542 ± 0.002^{bcdef} | 476.27 ± 9.64^{abcd} | 0.246 ± 0.004^{abc} |
| 3-3-2 | 363.27 ± 25.8^{ab} | 972.38 ± 5.87^{abc} | 0.931 ± 0.007^{abcde} | 0.533 ± 0.004^{ab} | 501.14 ± 25.39^{defg} | 0.25 ± 0.003^{abcde} |
| 1-3-1 | 364 ± 11.86^{ab} | 957.86 ± 9.41^{abc} | 0.938 ± 0.008^{cde} | 0.552 ± 0.001^{ghij} | 495.06 ± 7.76^{cdefg} | 0.256 ± 0.001^{cde} |
| 2-1-1 | 381.96 ± 10.85^{bcde} | 986.65 ± 20.39^{c} | 0.93 ± 0.005^{abcde} | 0.551 ± 0.005^{fghij} | 509.51 ± 4.84^{efgh} | 0.258 ± 0.008^{e} |
| 1-3-0 | 410.18 ± 6.0^{gh} | 1049.6 ± 32.61^{e} | 0.935 ± 0.011^{bcde} | 0.548 ± 0.003^{efghij} | 531.57 ± 18.5^{hi} | 0.251 ± 0.002^{abcde} |
| 2-3-0 | 416.97 ± 5.24^{h} | 1038.76 ± 13.37^{de} | 0.947 ± 0.013^{abcde} | 0.553 ± 0.005^{hij} | 539.77 ± 9.46^{j} | 0.259 ± 0.003^{e} |
| 2-2-0 | 412.08 ± 14.85^{h} | 1043.2 ± 29.45^{de} | 0.959 ± 0.013^{f} | 0.553 ± 0.008^{hij} | 545.04 ± 27.44ⁱ | 0.257 ± 0.005^{de} |
| 0-3-2 | 410.46 ± 18.87^{gh} | 970.59 ± 20.05^{abc} | 0.94 ± 0.011^{def} | 0.551 ± 0.008^{fghij} | 502.89 ± 13.2^{defg} | 0.251 ± 0.008^{abcde} |
| 0-3-1 | 403.59 ± 2.65^{fgh} | 978.8 ± 2.03^{bc} | 0.946 ± 0.004^{eg} | 0.555 ± 0.008^{ij} | 511.06 ± 12.68^{fgh} | 0.255 ± 0.004^{cde} |
| 3-1-0 | 413.77 ± 2.2^{h} | 1015.27 ± 1.79^{d} | 0.947 ± 0.006^{ef} | 0.547 ± 0.006^{fghij} | 519.5 ± 4.67^{ghi} | 0.255 ± 0.007^{cde} |
| 3-2-0 | 399.27 ± 2.79^{efgh} | 978.07 ± 3.28^{bc} | 0.914 ± 0.01^{a} | 0.537 ± 0.001^{bcd} | 480.68 ± 12.35^{abcd} | 0.242 ± 0.002^{a} |

All data are reported as means ± standard deviations.
The different letters after the values in the same column indicate the means is significantly different (p < 0.05).
ns means non-significant.

### 2.8.2 The Effect of Selected PSs on the Cooking Properties of Whole Semolina Pasta

TABLE 19
The cooking yield and cooking loss of whole
semolina pasta by adding selected PSs.

| No. | PSs % | Cooking yield % | Cooking loss % |
|---|---|---|---|
| 1 | Control | 122.09 ± 0.42^{c} | 5.22 ± 0.04^{c} |
| 2 | 0.4% TCP | 120.73 ± 0.79^{bc} | 5.07 ± 0.02^{b} |
| 3 | 0.3% CAPP | 119.6 ± 0.33^{ab} | 5.00 ± 0.05^{ab} |
| 4 | 0.25% SKMP | 118.98 ± 0.57^{a} | 5.19 ± 0.01^{c} |
| 5 | 0.15% SAPP | 120.34 ± 1.2^{ab} | 4.96 ± 0.06^{a} |

All data are reported as means ± standard deviations. The different letters after the values in the same column indicate the means is significantly different (p < 0.05). ns means non-significant.

As for cooking properties, the four selected PSs showed varied effect on the whole semolina pasta. The cooking yield couldn't be increased by adding TCP, CAPP, SKMP and SAPP, comparing with the control, as shown in Table 19. However, the addition of TCP, CAPP and SAPP could significantly decrease the cooking loss of whole semolina pasta.

### 2.7 Study on the Effect of PSs on the Mixolab Properties

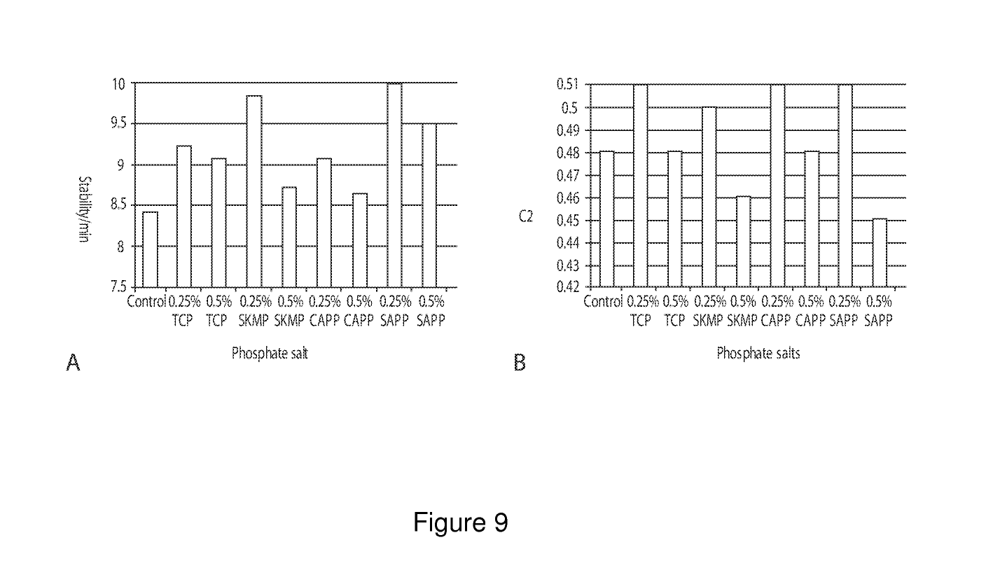

The mixolab is an instrument to measure the rheological behavior as a function of mixing and temperature increase in flours. In this study, the effect of four PSs (CAPP, TCP, SKMP, and SAPP) on the mixolab properties was investigated at the two addition levels, 0.25% and 0.5% respectively. Comparing to the control, the stability and C2 value were increased by adding 0.25% TCP, CAPP, SAPP and SKMP respectively, which were more effective than the addition level of 0.5% (FIG. 9). And the C4 value showed similar changes to the above two indexes at the level of 0.25%, but C1, C3, C5 didn't show it. In addition, adding 0.25% of each PS could improve the gluten strength during heating for SAPP.

### REFERENCES CITED

Wang, L., Hou, G. G., Hsu, Y.-H., and Zhou, L. 2011a. Effect of phosphate salts on the pasting properties of Korean instant-fried noodle. Cereal Chem. 88(2):142-146.
Wang, L., Hou, G. G., Hsu, Y.-H., and Zhou, L. 2011b. Effect of phosphate salts on the Korean non-fried instant noodle quality. Journal of Cereal Sci. 54: 506-512.
Zhou, Y, and Hou, G. G. 2011. Effects of phosphate salts on the pH values and RVA pasting parameters of wheat flour suspensions. Cereal Chem. doi: 10.1094/CCHEM-07-11-0090.
Hou, G. G. 2010b. Laboratory pilot-scale noodle manufacturing and evaluation protocols. In: Hou, G. G. (Ed.), Asian Noodles: Science, Technology, and Processing. John Wiley & Sons, Inc., Hoboken, N.J., pp. 183-225.
AACC International. Approved Methods of Analysis, 11th Ed. Method 66-50.01. Pasta and noodle cooking quality-firmness. Reapproved Nov. 3, 1999. AACC International, St. Paul, Minn., U.S.A. http://dx.doi.org/10.1094/AACCIntMethod-66-50.01.
Sissons, M. J., Schlichting, L. M., Egan, N., Aarts, W. A., Harden, S. and Marchylo, B. A. 2008. A standardized method for the instrumental determination of cooked spaghetti firmness. Cereal Chem., 85(3):440-444.
Zhou, Y. B. and Hou, G. G. 2012. Effects of phosphate salts on the pH values and Rapid Visco Analyser (RVA) pasting parameters of wheat flour suspensions. Cereal Chem. 89 (1): 38-43.

What is claimed is:

1. A pasta composition comprising flour, water, and a phosphate salt, wherein the phosphate salt is in an amount of from about 0.05% to about 5.0% by weight of the flour.

2. The pasta composition of claim 1, wherein the phosphate salt is in an amount of from about 0.1% to about 1.0% by weight of the flour.

3. The pasta composition of claim 1, wherein the pasta composition is a fresh pasta, a refrigerated pasta, or a frozen pasta.

4. The pasta composition of claim 3, wherein the pasta composition is a cooked refrigerated pasta or a cooked frozen pasta.

5. The pasta composition of claim 1, wherein the pasta composition is a semolina, wheat, or whole wheat pasta.

6. The pasta composition of claim 1, wherein the phosphate salt is selected from the group consisting of MSP, DSP, TSP, SAPP, TSPP, STPP, STMP, SHMP, DKP, DMP, SKMP, TCP, CAPP, MKP, TKPP, DCP, MCP, TKP, KTPP, phosphoric acid, and SALP.

7. The pasta composition of claim 1, wherein the phosphate salt is selected from the group consisting of MSP, DSP, TSP, SAPP, TSPP, STPP, STMP, SHMP, DKP, SKMP, TCP, and CAPP.

8. The pasta composition of claim 1, wherein the phosphate salt is selected from the group consisting of TCP, CAPP, SAPP, and SKMP.

9. The pasta composition of claim 1 comprising two or more phosphate salts.

10. The pasta composition of claim 9, wherein the two or more phosphate salts are a blend selected from the group consisting of a 0.1% CAPP+0.4% TCP, 0.2% CAPP+0.4% TCP, 0.2% CAPP+0.3% TCP, and 0.3% CAPP+0.2% TCP by weight of the flour.

11. The pasta composition of claim 9, wherein the two or more phosphate salts are selected from the group consisting of MSP, DSP, TSP, SAPP, TSPP, STPP, STMP, SHMP, DKP, SKMP, TCP, and CAPP.

12. The pasta composition of claim 9, wherein the two or more phosphate salts are selected from the group consisting of CAPP, TCP, SAPP, and SKMP.

13. The pasta composition of claim 1, wherein the pasta composition comprises up to about 10% by weight of the flour of egg white.

14. The pasta composition of claim 13, wherein the pasta composition comprises from about 2% to about 7% by weight of the flour of egg white.

15. The pasta composition of claim 1, wherein the pasta composition comprises less than 2% by weight of the flour of egg white.

16. The pasta composition of claim 1, further comprising at least one additive selected from the group consisting of gluten, soy protein, gums, starches, fiber, and emulsifiers.

17. A method of making a pasta composition comprising mixing a phosphate salt with a pasta dough comprising flour and water, wherein the phosphate salt is in an amount of from about 0.05% to about 5.0% by weight of the flour.

18. The method of claim 17, wherein the phosphate salt is in an amount of from about 0.1% to about 1.0% by weight of the flour.

19. The method of claim 17, wherein the pasta composition is a fresh pasta, a refrigerated pasta, or a frozen pasta.

20. The method of claim 19, wherein the pasta composition is a cooked refrigerated pasta or a cooked frozen pasta.

21. The method of claim 17, wherein the pasta composition is a semolina, wheat, or whole wheat pasta.

22. The method of claim 17, wherein the phosphate salt is selected from the group consisting of MSP, DSP, TSP, SAPP, TSPP, STPP, STMP, SHMP, DKP, DMP, SKMP, TCP, CAPP, MKP, TKPP, DCP, MCP, TKP, KTPP, phosphoric acid, and SALP.

23. The method of claim 17, wherein the phosphate salt is selected from the group consisting of MSP, DSP, TSP, SAPP, TSPP, STPP, STMP, SHMP, DKP, SKMP, TCP, and CAPP.

24. The method of claim 17, wherein the phosphate salt is selected from the group consisting of TCP, CAPP, SAPP, and SKMP.

25. The method of claim 17 comprising mixing two or more phosphate salts with the pasta dough.

26. The method of claim 25, wherein the two or more phosphate salts are a blend selected from the group consisting of a 0.1% CAPP+0.4% TCP, 0.2% CAPP+0.4% TCP, 0.2% CAPP+0.3% TCP, and 0.3% CAPP+0.2% TCP by weight of the flour.

27. The method of claim 25, wherein the two or more phosphate salts are selected from the group consisting of MSP, DSP, TSP, SAPP, TSPP, STPP, STMP, SHMP, DKP, SKMP, TCP, and CAPP.

28. The method of claim 25, wherein the two or more phosphate salts are selected from the group consisting of CAPP, TCP, SAPP, and SKMP.

29. The method of claim 17, wherein the pasta composition comprises up to about 10% by weight of the flour of egg white.

30. The method of claim 29, wherein the pasta composition comprises from about 2% to about 7% by weight of the flour of egg white.

31. The method of claim 17, wherein the pasta dough comprises less than 2% by weight of the flour of egg white.

32. The method of claim 17, wherein the method further comprises mixing at least one additive selected from the group consisting of gluten, soy protein, gums, starches, fiber, and emulsifiers with the pasta dough.
